(19) United States
(12) Patent Application Publication
(10) Pub. No.: US 2021/0264666 A1
(43) Pub. Date: Aug. 26, 2021

(54) METHOD FOR OBTAINING PHOTOGRAMMETRIC DATA USING A LAYERED APPROACH

(71) Applicant: REIGN MAKER VISUAL COMMUNICATIONS LLC, Hortonville, NY (US)

(72) Inventors: Jessica CHOSID, Callicoon, NY (US); Tyris AUDRONIS, Katy, TX (US)

(73) Assignee: REIGN MAKER VISUAL COMMUNICATIONS LLC, Hortonville, NY (US)

(21) Appl. No.: 17/191,834

(22) Filed: Mar. 4, 2021

Related U.S. Application Data
(63) Continuation of application No. PCT/US2019/049504, filed on Sep. 4, 2019.
(60) Provisional application No. 62/726,739, filed on Sep. 4, 2018.
(60) Provisional application No. 62/726,749, filed on Sep. 4, 2018.

(51) Int. Cl. G06T 17/05; H04N 5/232; G06T 15/04; G01C 11/02; B64C 39/02

(52) U.S. Cl. CPC G06T 17/05; H04N 5/23299; B64C 2201/127; G01C 11/02; B64C 39/024; G06T 15/04

(57) ABSTRACT

A method and system for acquiring photogrammetric data of a target object and generating a three-dimensional model of the target object is provided. The present disclosure provides a method and system for acquiring photogrammetric data of the target object while moving a camera along paths for optimal data acquisition. The present disclosure further provides a method and system for the efficient processing of the acquired photogrammetric data into a three-dimensional model.

### CROSS REFERENCE TO RELATED APPLICATIONS

This application is a continuation of International Patent Application No. PCT/US19/49504 filed on Sep. 4, 2019, which claims priority under 35 U.S.C. § 119(e) to both U.S. Provisional Patent Application No. 62/726,739 filed on Sep. 4, 2018, and U.S. Provisional Patent Application No. 62/726,749 filed on Sep. 4, 2018, the contents of all of which are incorporated by reference herein in their entirety.

### BACKGROUND OF THE DISCLOSURE

### 1. Field of the Disclosure

The present disclosure relates to a method and a system for improved photogrammetric data collection, and processing of the data to generate improved 3D models. More particularly, the present disclosure relates to a method and a system for determining optimal paths for obtaining photogrammetric data, such as photographs, and the processing of the data into high quality 3D models.

### 2. Description of the Related Art

Current practices for building 3D models from photogrammetric data, result in low quality 3D models with low resolution, low polygon counts and/or low quality textures. Furthermore, higher quality 3D models take longer processing times to generate, which can take up valuable time and resources.

Existing practices for building 3D models have unmanned aerial vehicle (UAV) pilots to use a trial and error method to discover which distances to fly to acquire desired image resolutions for a particular project. Thus, it is difficult to quickly obtain the correct flight paths, flight patterns and distances required to obtain quality photogrammetric data and the required resolution of the final 3D model.

Additionally, it is difficult to quickly generate high quality 3D models with quality textures with current data collection practices, and with current data processing methods.

Thus, there is a need to address the foregoing problems.

### SUMMARY OF THE DISCLOSURE

The present disclosure provides a method and a system that addresses at least the aforementioned shortcomings of current methods for obtaining photogram metric data, and for quickly processing the acquired data to generate high quality 3D models. Photogrammetry is the process of generating 3D data based on multiple 2D photographs based on parallax.

The present disclosure further provides such a method and a system that calculates optimal flight paths and distances for collecting photogrammetric data, based on data, such as the object or building's dimensions, and surrounding obstructions. The present disclosure further allows a user to input the desired resolution for the final 3D model and obtain the required distances and flight paths necessary to achieve this resolution from the disclosed method and system. The photogram metric data is gathered using a layered approach, encompassing various flight patterns around a target. The method and system further calculates optimal vertical and horizontal spacing for taking successive photographs with sufficient overlap, and the various distances required for inner and outer orbit loops, and boustrophedonic texture passes and high and low boustrophedonic nadir passes. The UAVs can be programmed to perform the calculated flight paths, or in some embodiments be controlled by an operator.

The calculated flight paths, including outer and inner orbit passes, and high and low nadir passes, produce 3D parallax data that enables photogrammetric software to produce higher quality 3D models with more accuracy. Additionally, the texture pass data provides high quality texture data for integration with the higher quality 3D model.

During data processing, the tie points for all the data are generated, including the photos acquired during the 3D parallax and texture passes, such that the 3D parallax and texture passes will share tie points. The 3D parallax data is processed first to produce a highly accurate and, in some embodiments, also a higher resolution base 3D model. High quality texture data from the texture passes is then integrated with the base 3D model to quickly produce the final textured 3D model. The separate handling and processing of the 3D model data, and subsequently the texture data enables the final 3D model to be generated significantly quicker than current practices allow.

### BRIEF DESCRIPTION OF THE DRAWINGS

The application file contains at least one drawing executed in color. Copies of this patent or patent application publication with color drawing(s) will be provided by the Office upon request and payment of the necessary fee.

FIG. 1 is a flow chart illustrating an embodiment of how data is collected, paths determined, photogrammetric data acquired, and processed into a 3D model.

FIG. 2 is a flow chart illustrating an embodiment of how data is acquired, stored, calculated, and paths determined.

FIG. 3 illustrates the viewing angle, and area covered by a camera.

FIG. 4 illustrates the vertical and horizontal pixel dimensions of a photo.

FIG. 5 illustrates the percent overlap of the fields of view of a camera, as the camera takes successive photographs during data acquisition.

FIG. 6 is a flow chart illustrating an embodiment of how data is acquired on various flight paths.

FIG. 7A illustrates inner orbit passes around a building.

FIG. 7B illustrates a photo taken of a building during an inner orbit pass.

FIG. 8A illustrates a low nadir pass above a building.

FIG. 8B illustrates a photo taken during a low nadir pass above a building.

FIG. 9A illustrates outer orbit passes relative to the inner orbit passes around a building.

FIG. 9B illustrates a photo taken of a building during an outer orbit pass.

FIG. 10A illustrates a high nadir pass relative to a low nadir pass above a building.

FIG. 10B illustrates a photo taken during a high nadir pass above a building.

FIG. 11A illustrates a texture pass around a building and a texture nadir pass above a building.

FIG. 11B illustrates a photo taken during a texture pass around a building.

FIG. 12 illustrates outer orbit passes relative to a high nadir pass around a building.

FIG. 13 illustrates both high and low nadir passes above a building, and both inner and outer orbit passes around a building.

FIG. 14 illustrates a texture pass and a texture nadir pass around a building.

FIG. 15 is a flow chart illustrating an embodiment of how data is processed to produce a 3D model.

FIG. 16 is a block diagram of a method computer system used to implement the method and system.

FIG. 17 is a block diagram of a server computer system used to implement the method and system.

FIG. 18 illustrates the generation of tie in points from photogrammetric data.

FIG. 19 illustrates the generation of point clouds from photogrammetric data.

FIG. 20A illustrates the solid geometry of a 3D model without textures.

FIG. 20B illustrates the wireframe of the generated polygons of the 3D model.

FIG. 21 illustrates the decimated mesh of the 3D model.

FIG. 22A illustrates an embodiment of a 3D model with textures.

FIG. 22B illustrates a close up of a side of 3D model with textures.

FIG. 23 illustrates a very high resolution side orthogonal image of the 3D model.

FIG. 24A shows positional data from FIG. 19.

FIG. 24B shows positional data from FIG. 20A.

FIG. 24C shows positional data from FIG. 20B.

FIG. 24D shows positional data from FIG. 21.

FIG. 24E shows positional data from FIG. 22A.

FIG. 24F shows positional data from FIG. 22B.

### DESCRIPTION OF EXEMPLARY EMBODIMENTS

The present disclosure provides a method and a system for improved photogrammetric data collection using a layered approach, and processing of the data to generate improved 3D models. The layered approach encompasses the use of various flight patterns, such as inner and outer orbital passes, high and low nadir passes, and texture passes. When more of the flight patterns are used, the accuracy of the final 3D model increases.

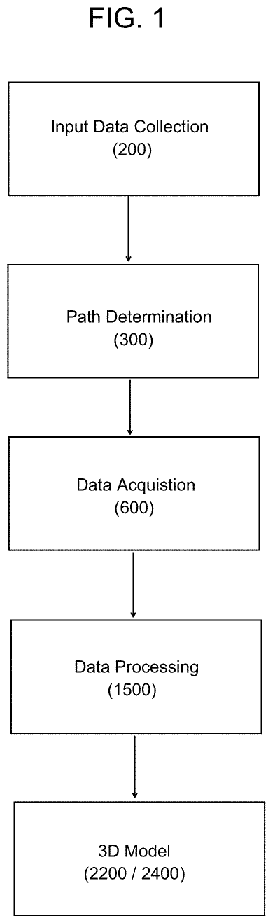

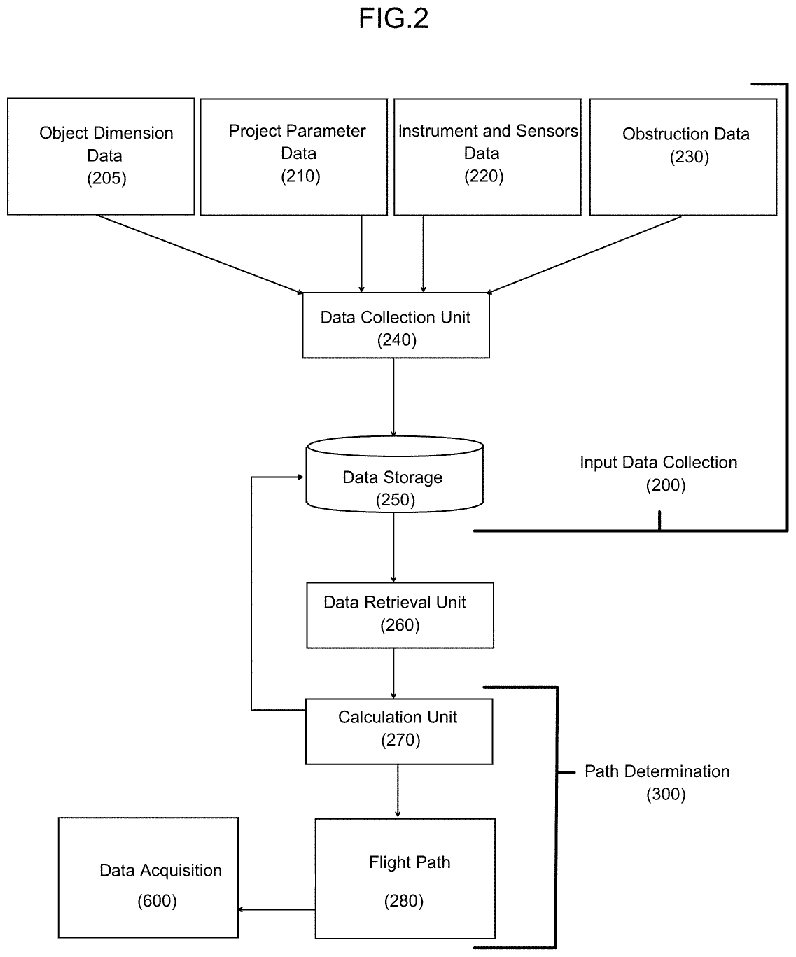

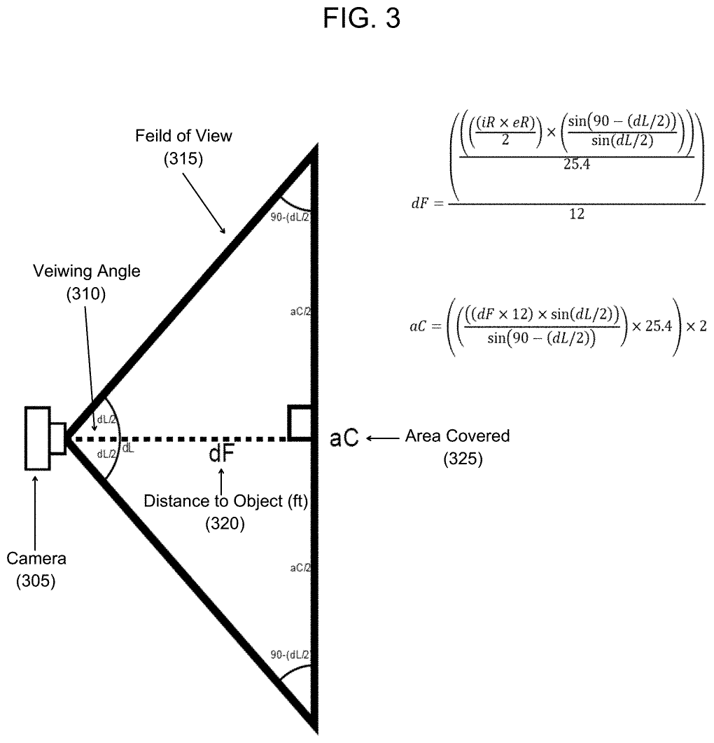

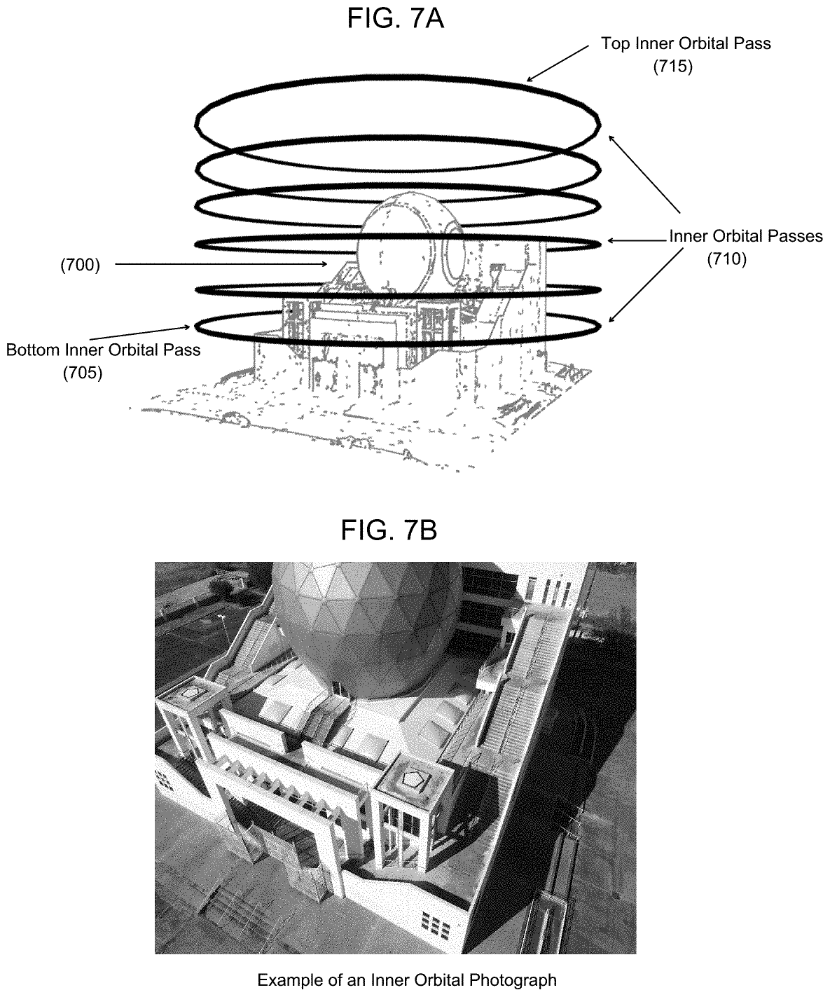

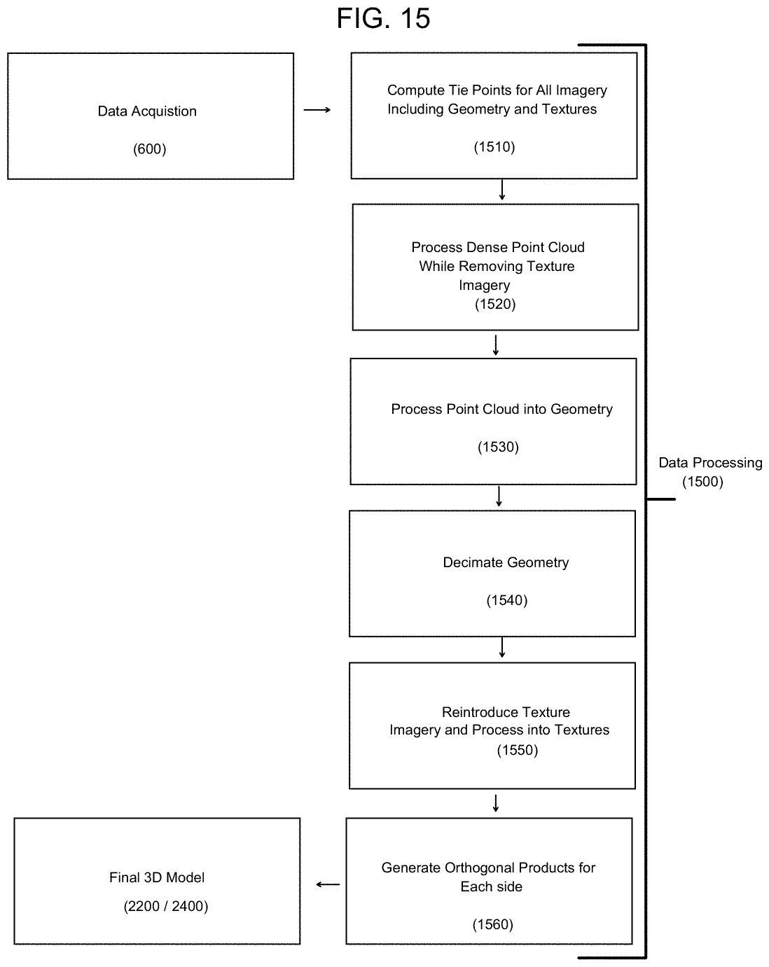

Referring to the drawings and in particular, to FIG. 1, a flow chart is shown illustrating an embodiment of how data is acquired, stored, calculated and processed at a high level according to the present disclosure. The input data collection 200 and path determination 300 is further detailed in FIG. 2. FIGS. 3-6 further describe path determination 300 and data acquisition 600. FIGS. 7A-14 further describe the flight paths used to acquire data during data acquisition 600. Data processing steps 1500 are detailed in FIG. 15. The embodiments in FIG. 1 are present and implemented in all other embodiments described hereafter.

FIG. 2 is an embodiment of a system architecture used to implement the method and system disclosed herein.

Data collection unit 240 collects data from various sources, such as the object dimensions data 205 (or the building or target being modeled), the project parameter data 210, the instrument and sensors data 220, and the obstruction data 230. Data collection unit 240 can also collect relevant data from the internet, or third parties. Unit 240 can collect data, via a user interface, or diagnostic questionnaire or other conventional methods.

Data collection unit 240 can be a program module that acquires and stores the data.

The object dimension data 205 can include the object's height, width, length, circumference, and perimeter. The dimensions can be in any measurement unit, such as meters, or feet. Object dimension data 205 can be collected directly from the owner of the object or building, any third party having possession of the data, government data bases, the internet, or from existing maps, drawings or charts containing such information, or through measurements where possible.

Project parameter data 210, contains information regarding the type of object or target being modeled, the desired resolution, or level of detail, desired resolution and desired accuracy of the final 3D model, and other information relevant to the modeling of the object. Such information can include the owner of the object or building, GPS coordinates and boundaries of the building, and the type of airspace (restricted or not) surrounding the object or building. The information can further include desired quality or accuracy levels of the final 3D model.

Instrument and sensor data 220, can include the data on the type of camera used to obtain photogrammetric data of the object or building. The resolution in megapixels, and zoom capabilities of the camera, camera angles, field of view, and the weight can be included in data 220. Data 220 can further include data regarding the particular sensors, instruments, or equipment available on a UAV. The sensors on the UAV can include but are not limited to radar, lidar, sonar, optical, and infrared sensors. The UAV can further include computer components such as a wireless communication device, a processor, and data storage device, with instructions on how to fly the calculated and selected paths.

Obstruction data 230 can include data on any obstructions surrounding or near the object or building of interest. The obstructions can include powerlines, telephone poles, wiring, trees, scaffolding, and adjacent buildings or objects. Data 230 can include the dimensions of the obstructions, such the height, length, width, and perimeter, and further include the obstructions GPS coordinates.

Data collection unit 240 collects the information and then stores it in data storage 250. Data storage 250 can be a program module for providing instructions on how and where to store the collected data. Data storage 250 can store the data, on various storage mediums, such as, but not limited to, hard drives, cloud storage, or databases or any combination thereof.

Data retrieval unit 260 retrieves data stored by data storage 250. In some embodiments, data retrieval unit 260 is a program module, for retrieving the data stored by data storage 250. In some embodiments, data retrieval unit 260 can also prompt data collection unit 240 to collect data not initially collected. Data retrieval unit 260 can also prompt data collection unit 240 in the event data is found to be missing. Data retrieval unit 260 supplies the data to calculation unit 270.

Calculation unit 270 performs calculations on the previously collected and stored data. The results of the calculations provide the basis for the camera path and/or flight path selection. In some embodiments, calculation unit 270 is a program module for calculating data previously collected and stored.

Calculation unit 270 can calculate results of the equations listed below, based on the data available in data storage 250. In some embodiments, calculation unit 270 can also calculate results based on data received from a display and user interface, or data received over a network.

Calculation unit 270 can use at least the following equations:

$$d F = \frac{( \frac{( ( \frac{( i R \times e R )}{2} ) \times ( \frac{sin ( 90 - ( d L / 2 ) )}{sin ( d L / 2 )} ) )}{25.4} )}{12}$$

$$a C = ( ( ( \frac{( ( d F \times 12 ) \times sin ( d L / 2 ) )}{sin ( 90 - ( d L / 2 ) )} ) \times 25.4 ) \times 2 )$$

$$aC ( in feet ) = ( ( ( \frac{( ( d F \times 12 ) \times sin ( d L / 2 ) )}{sin ( 90 - ( d L / 2 ) )} ) \times 25.4 ) \times 2 ) \times 0.00328$$

aC(vertical) is calculated based on a dF calculated from a vertical iR
aC(horizontal) is calculated based on a dF calculated from a horizontal iR

$$a C ( g P ) = ( ( ( \frac{( ( g P \times 12 ) \times sin ( d L / 2 ) )}{sin ( 90 - ( d L / 2 ) )} ) \times 25.4 ) \times 2 ) \times . 00328 \\ a C ( g F ) = ( ( ( \frac{( ( g F \times 12 ) \times sin ( d L / 2 ) )}{sin ( 90 - ( d L / 2 ) )} ) \times 25.4 ) \times 2 ) \times . 00328$$

$$e R = ( \frac{a C}{i R} )$$

$$eR ( in mm ) = ( \frac{a C}{i R} ) \times 304.8$$

$$o L = a C - ( ( \frac{p L}{100} ) \times a C )$$

$$g P = d F \times ( 5 - ( a F \times 3 ) )$$

$$g F = g P \times ( 1 + ( 1.1 - aF ) )$$

$$oL ( Texture or Nadir Pass ) = ( \frac{o L}{Aspect Width} ) \times Aspect Height$$

$$oL ( Texture or Nadir pass Vertical ) = aC ( Vertical ) - ( ( \frac{p L}{100} ) \times aC ( vertical ) )$$

$$oL ( Texture or Nadir pass Horizontal ) = aC ( Horizontal ) - ( ( \frac{p L}{100} ) \times aC ( Horizontal ) )$$

### Altitude Low Nadir=Height of Target+gP

### Altitude High Nadir=Height of Target+gF

### Altitude of Texture Nadir=Height of Target+dF

dF=distance in feet

$$d L = 2 \times tan ( \frac{\sqrt{s {V}^{2} + s {H}^{2}}}{2 \times IL} )$$

dL=degrees of lens field of view
iR=one dimension (either horizontal or vertical) image resolution in pixels (specification of sensor)
eR=how many millimeters per pixel effectively per image
pL=percentage of overlap
oL=distance between pictures during pass (can be in feet, and can be horizontal or vertical)
aC=area covered by an image in one dimension in feet (can be horizontal or vertical)
aF=a number representing desired geometric accuracy from a scale from 0 to 1 (0 being the lowest quality and 1 being the highest)
gP=geometry pass close distance
sV=the sensor physical vertical measurement in millimeters.
sH=the sensor physical horizontal measurement in millimeters
lL=the focal length of the lens in millimeters
pN=number of passes to be flown based on aF as defined below:

| aF | pN: Passes corresponding to each aF |
|---|---|
| 0 to 0.25 | Texture, Texture Nadir, High Nadir, Outer Orbit |
| >0.25 to 0.5 | Texture, Texture Nadir, High Nadir, Inner Orbit |
| >0.5 to 0.75 | Texture, Texture Nadir, High Nadir, Inner Orbit, Outer |
| | Orbit |
| >0.75 to 1.0 | Texture, Texture Nadir, High Nadir, Low Nadir, Inner |
| | and Outer Orbit. |

Once calculation unit 270 obtains the results of the calculations, calculation unit 270 can provide the results to a display and user interface.

Based on the results of the calculations, calculation 270 will obtain the necessary distances for the outer and inner orbits, texture passes, and high and low nadir passes. In some embodiments, calculation unit 270 will compare the path of the orbits and nadir passes, to the locations of any known obstructions from obstruction data 230. Calculation unit 270 can adjust the orbit and nadir passes to avoid the obstructions by either increasing or decreasing the distance of the orbits and/or nadir passes, so that the flight path no longer intersects an obstruction. In some embodiments, the distances can be increased or decreased in increments of predetermined percentages until the obstructions are cleared. In some embodiments, calculation unit 270 will provide these alternatives for viewing and selection through the use of a display interface. The alternative paths can be displayed as an overlay on an existing map or an existing 3D model of the object. In some embodiments based on a user selected aF, the corresponding number and type of flight passes will be conducted.

For example, for an aF of 0 to 2.5, four passes will be conducted which include a texture pass, texture nadir pass, high nadir pass, and an inner orbit pass, for a lower quality 3D model. For an aF of >0.25 to 0.5, four passes will be conducted which include a texture pass, texture nadir pass, high nadir pass, and an outer orbit pass for an average quality 3D model. For an aF of >0.50 to 0.75, five passes will be conducted which include a texture pass, texture nadir pass, high nadir pass, inner orbit pass and an outer orbit pass for a high quality 3D model. And for an aF of >0.75 to 1, six passes will be conducted which include a texture pass, texture nadir pass, high nadir pass, low nadir pass, inner orbit pass and an outer orbit pass for a very high quality 3D model. Thus, the higher the selected aF, the greater the number and type of passes, which result in final 3D models with increasing accuracy. Although parallax in the 3rd dimension is needed, below a certain threshold of quality, the geometry passes can be taken from the gF distance in the interest of saving the number of images required for these passes (rather than the gP distance).

Calculation unit 270 will also determine if the sensors and/or instruments are sufficient to meet the project parameters, based on project parameter data 210 and instrument and sensor data 220. For example, if an available camera at a certain megapixel resolution is not sufficient to meet the desired resolution as set by the project parameters at a certain distance for the orbital and nadir passes, calculation unit 270 can recommend a higher resolution camera for farther distance passes, needed to avoid obstructions.

In some embodiments, calculation unit 270 can pick the optimal orbital and nadir pass routes based on the input data collection 200. Calculation unit 270 can also display all available routes to meet the project parameters, and avoid known obstructions on a display and user interface, so that a UAV operator can pick a desired route. In some embodiments, the routes or flight paths are shown on a display and a user can alter the flight path, or make adjustments through a user interface, such as a touch screen, or mouse and keyboard. Calculation unit 270 then saves the calculations and flight path 280 in data storage 250. Calculation unit 270 can calculate and provide the optimal distances, and flights paths, and adjust the flight paths based on obstructions, in seconds or minutes, and in some less preferred embodiments, hours.

In some embodiments, when calculation unit 270 receives the changes or inputs from the user interface, calculation unit 270 conducts updated calculations and updates the flight path 280. Calculation unit 270 can conduct the updated calculations based on information received from the user interface of display, or calculation unit 270 may request updated information from data storage 250. Data storage 250 provides the updated information to calculation unit 270 through retrieval unit 260.

In some embodiments, when data storage 250 is unable to find the updated or requested data from calculation unit 270, data storage 250 requests the data from data collection unit 240.

Once calculation unit 270, or a UAV operator pick the desired flight path, the flight path 280 is used to acquire data during data acquisition 600.

FIG. 3 illustrates a camera 305, used in acquiring the photogrammetric data, and the viewing angle dL 310 of the camera. The viewing angle dL 310 of the camera is obtained from instrument and sensor data 220 or by using specification data of the sensor and lens as defined by sV, sH and lL. The field of view 315 represents the field of view of the camera 305 based on the viewing angle 310 of the camera. The area covered aC 325, is determined by the distance in feet dF 320, between the camera, and the surface of the object or building being viewed through the camera with a viewing angle dL. The relationship between the distance in feet dF and the area covered aC is provided by the following equations:

$$d F = \frac{( \frac{( ( \frac{( i R \times e R )}{2} ) \times ( \frac{sin ( 90 - ( d L / 2 ) )}{sin ( d L / 2 )} ) )}{25.4} )}{12}$$

$$aC ( in feet ) = ( ( ( \frac{( ( d F \times 12 ) \times sin ( d L / 2 ) )}{sin ( 90 - ( d L / 2 ) )} ) \times 25.4 ) \times 2 ) \times . 00328$$

$$d L = 2 \times tan ( \frac{\sqrt{s {V}^{2} + s {H}^{2}}}{2 \times IL} )$$

The distance dF is the maximum distance a camera would have to be away from the object or building in order to achieve a desired image resolution eR measured in millimeters (mm) per pixel.

The area covered aC is the surface area of the object or building covered by a camera taking a photograph at a distance dF with a viewing angle dL. The dL parameter is the viewing angle for the camera based on the sensor width sH, sensor height sV and lens focal length, lL in millimeters.

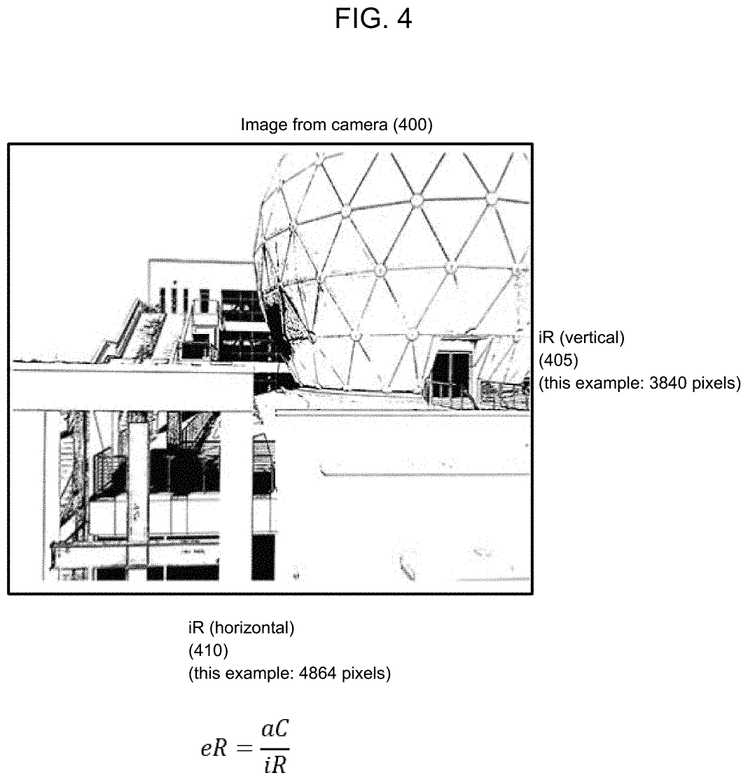

FIG. 4 illustrates a picture 400 taken from the camera used to obtain photogrammetric data during the flight passes. The vertical or horizontal dimensions measured in pixels is represented by iR. In the example shown in FIG. 4, the vertical iR (405) is 3840 pixels, and the horizontal iR (410) is 4,864 pixels. The vertical and horizontal iR can be obtained from the instrument and sensors data 220 or the camera specifications. The vertical iR can be used to calculate how much lower or higher another photo must be taking to achieve a desired overlap percentage. The horizontal iR can be used to calculate how many feet horizontally a picture must be taken to achieve a desired overlap percentage. These calculations will be further described below. The desired image resolution eR can be obtained from the project parameter data 210, or can be calculated with the following equation:

$$eR ( in mm ) = ( \frac{a C}{i R} ) \times 304.8$$

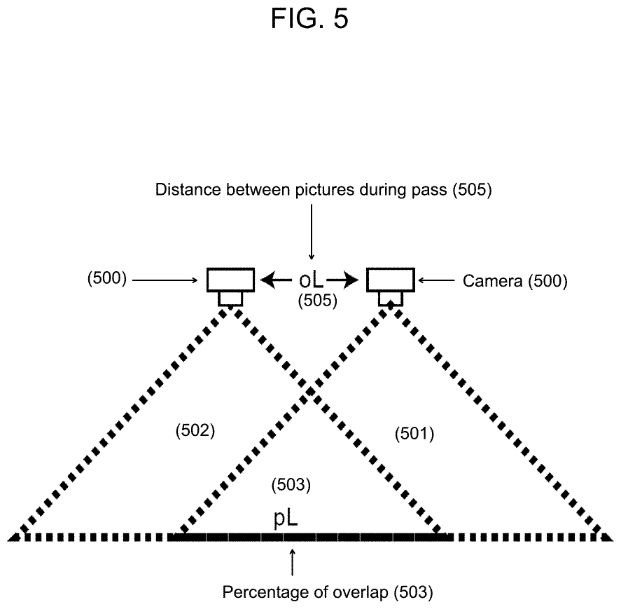

FIG. 5 illustrates the percentage of overlap 503 of the field of views 501 and 502, of a camera 500, as the camera takes successive photographs during the flight passes. The camera has a first field of view 501, in which the camera takes a first photograph of the object or building. The camera then moves a distance oL (505), and then takes a second photograph when it's field of view coincides with 502. The percentage of overlap pL (503) represents the overlap of the first and second fields of view 501 and 502 in relation to the area covered with either photograph.

The camera 500 must take photographs every oL feet, with sufficient overlap pL, when obtaining photogrammetric data, such that a photogrammetric program is able to use the data to construct a 3D model and integrate textures with the 3D model.

The distance between photographs taken during a flight pass is represented by the following equation:

$$o L = a C - ( ( \frac{p L}{100} ) \times a C )$$

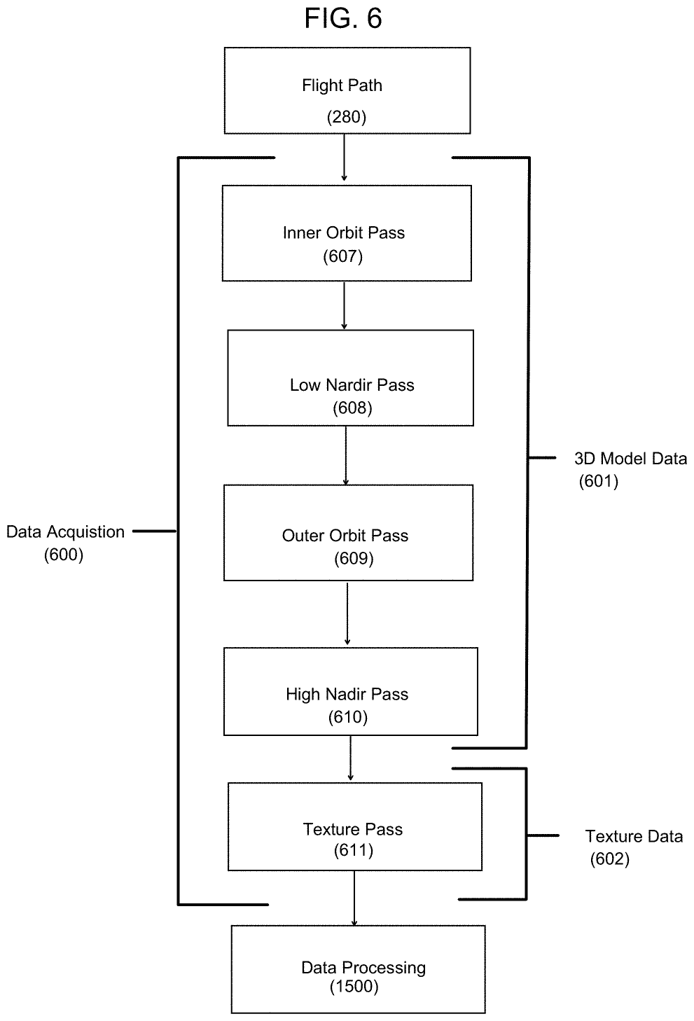

FIG. 6 is a flow chart illustrating a high-level overview of an embodiment of how data is acquired on various flight paths. In some embodiments, the path of the camera along the calculated paths is not limited to the use of a UAV. The camera may travel the path routes, either manually or robotically along a guided rail or track or be moved via a flexible robotic arm when modeling smaller objects for example.

Once the flight path 280 is set, the UAV follows a predetermined route. The UAV can fly the route autonomously, through the use of software, or a UAV operator can manually fly the UAV along the predetermined routes around the object or building through the use of a remote control.

The following routes for the inner and outer orbit passes, high and low nadir passes, and texture passes can be conducted in any order. In some embodiments, the inner orbital pass is first, the outer orbital pass is second, the low nadir pass is third, the high nadir pass is fourth, the texture pass is fifth, and the texture nadir pass is sixth. In some embodiments, the texture nadir pass is not required, as per project parameters. On orbital passes the camera faces inward (toward the center of the orbit path) toward the object or building, and in some embodiments be angled downward at 45 degrees to keep the target object in view, or at any angle appropriate to keep the target in view. On nadir passes (including texture nadir passes) above the object or building, the camera faces straight down toward the object or building without any angle or tilt. On texture passes, the camera faces inward and straight toward the object or building without any tilt or angle. In some embodiments, the number and type of passes conducted are based on the selected aF parameter, as described above. In some embodiments, data is associated with each picture taken during any of the passes. The data can include but is not limited to the longitude, latitude, and altitude corresponding to each picture. The data can be obtained from the sensors on the UAV (such as GPS, altimeter, and/or barometer), corresponding to the time stamp of the picture.

Inner orbit pass 607 is flown at a distance gP away from the target, in a circumferential, circular, or elliptical loop around the target. Inner orbit pass 607 should be flown around the object or building at various heights. Inner orbit pass 607 is further described in FIG. 7A.

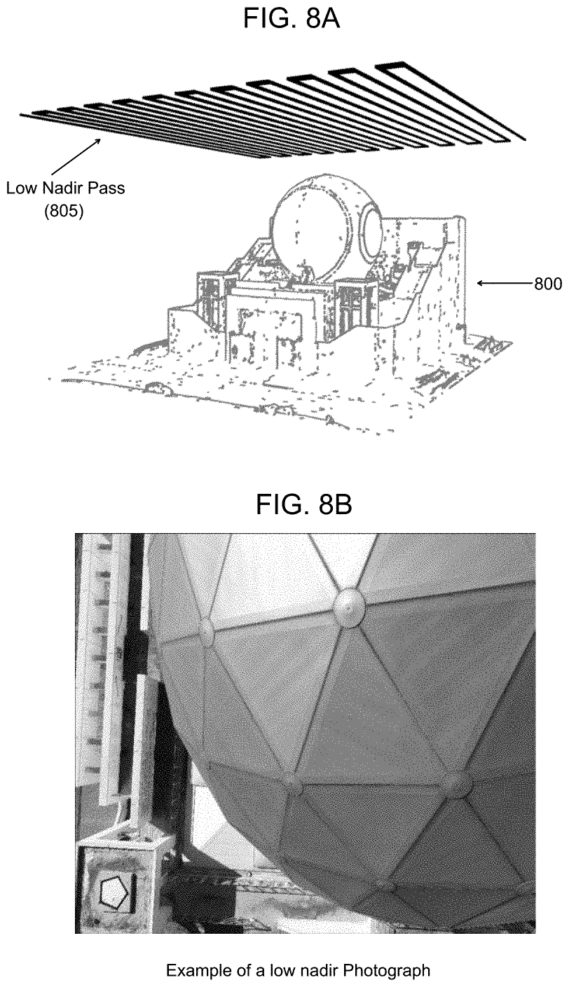

Low nadir pass 608, is flown at an additional distance gP above the height of the target. Low nadir pass 608 is a boustrophedonic pass. Low nadir pass 608 is further described in FIG. 8A

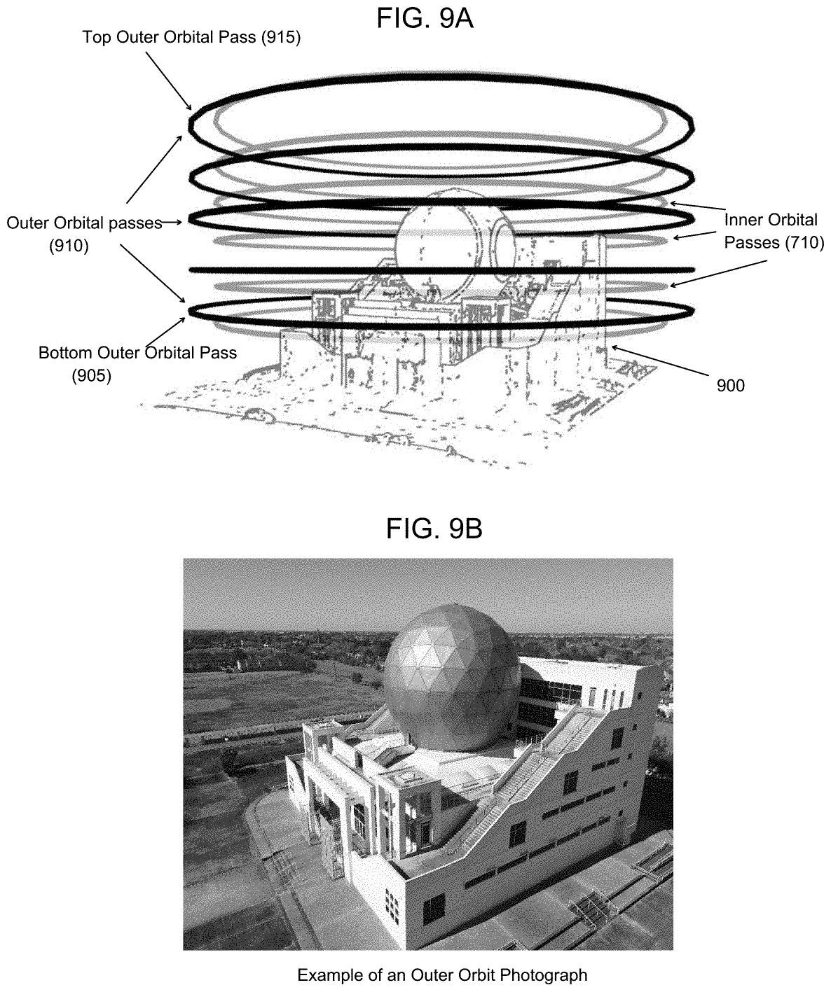

Outer orbit pass 609 is flown at a distance gF away from the target, in a circumferential, circular, or elliptical loop around the target. Outer orbit pass 609 should be flown around the target at various heights. Outer orbit pass 608 is further described in FIG. 9A.

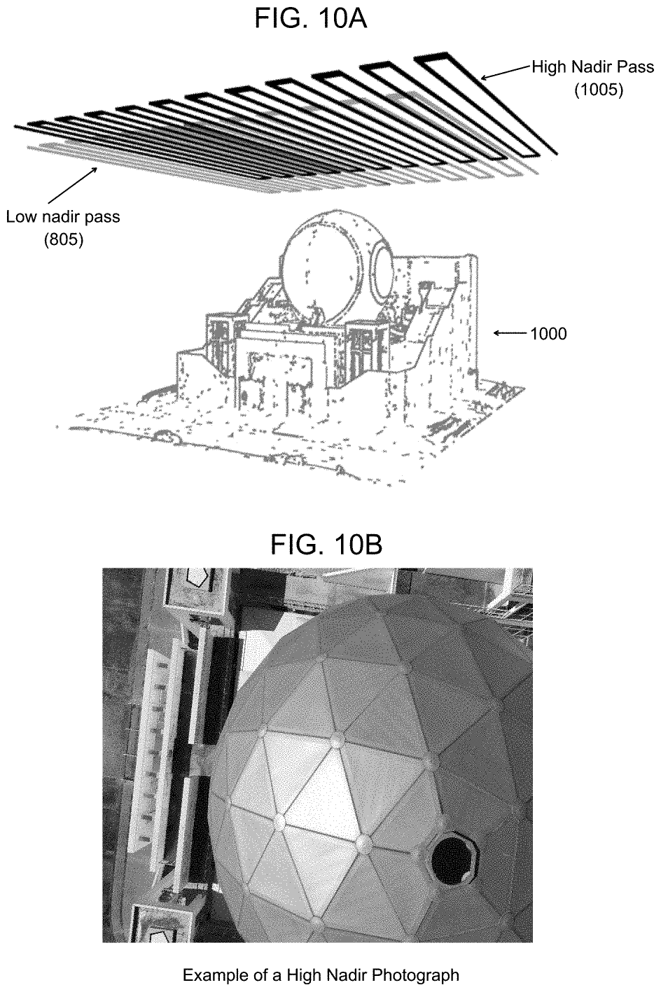

High nadir pass 610, is flown at an additional distance gF above the height of the target. High nadir pass 610 is a boustrophedonic pass flown above the height of the low nadir pass 608. High nadir pass 610 is further described in FIG. 10A.

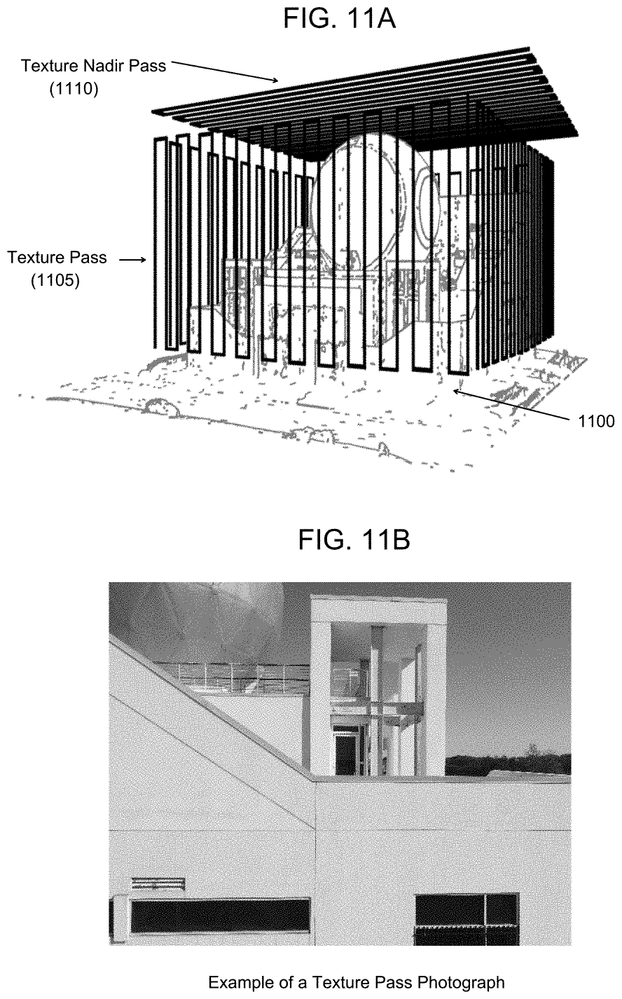

Texture pass 611 is flown at a distance dF from the target. Texture pass 611 is a boustrophedonic pass. In some embodiments, texture pass 611 further includes a boustrophedonic texture nadir pass flown at an additional distance dF above the target. Texture pass 611 is further described in FIG. 11A.

Photographs taken during the Inner and outer orbital passes 607 and 609, and high and low nadir passes 608 and 610 together produce 3D parallax data used by photogrammetric software during data processing 1500 to produce a 3D model. Photographs taken during the texture and texture nadir passes are used to generate the texture data, during data processing 1500 for use with the 3D model.

FIG. 7A illustrates an example of stacked inner orbital passes 710 around a building 700. The shape of the inner orbital passes can be circumferential, circular, square, triangular, rectangular, elliptical, or have the shape of the perimeter of the target object. The passes move the camera around the building or object. In some embodiments, at least two inner orbit passes which are stacked are needed to obtain the photogrammetric data. The camera on the UAV is angled with a progressive downward tilt starting at 0 degrees or level with the ground, on the bottom orbital pass 705 and to a 45 degree downward tilt, at the top orbital pass 715 so that the target is always in view. The orbits all remain the same distance gP, and the same shape as the bottom inner orbit pass 705 from the building regardless of altitude. The orbits can begin with the bottom inner orbital pass 705 with each subsequent inner orbit pass conducted with an altitude increase of oL (vertical), with the orbits ending with the top inner orbital pass 715. The bottom inner orbital pass begins with the camera pointed at the base of the target centered in the frame, and each consecutive orbit is stacked with an altitude increase of oL(vertical). The vertical distance oL for the stacked orbits, is calculated based on an area covered aC, which in turn is based on the distance gP (gP is substituted in place of dF in the aC equation), and the vertical distance iR (vertical pixel dimension). The vertical oL is calculated so that the pictures taken at each altitude in the stack have a minimum of a 60% overlap or pL with the pictures in the stacked orbits above and/or below the current picture. In some embodiments, the overlap can be in a range of less than 100% and with a minimum of 60%. For example, some embodiments have a range of a minimum of 60% overlap to a maximum of 99.99999% overlap. During a single inner orbit pass, pictures are taken every oL in the horizontal direction, as the camera moves around the target. During the orbit pass, oL (horizontal) feet are measured using the iR horizontal pixel dimension, while aC is measured using the gP distance as described above. The inner orbits end with the top inner orbit pass 715. The top inner orbit is the altitude of the height of the target plus gP. In some embodiments the number of stacked orbits is calculated by dividing the height of the top inner orbit pass, by the vertical overlap. In some embodiments, the orbits may start with the top inner orbital pass 715 and decrease in an attitude of oL (vertical) and end with the bottom inner orbital pass 705.

For example, a UAV, with a lens field of view dL of 84 degrees (used in all the following examples), with an aspect ratio of 4:3. if the desired resolution of an image eR is 2 millimeters, the desired geometric accuracy aF is 0.8 (80%), and the horizontal iR of 4,864 pixels is used, the dF is calculated to be 21 feet 7-inches. Based on the calculated dF, the distance gP for the inner orbit pass should be 56-feet and 1 inch. However due to obstacles, a pass at 56 feet and 1 inch is not possible. In some embodiments, the calculation unit 270 increases or decreases the flight radius of gP feet until the flight path of the UAV no longer intersects the obstruction. In other embodiments, the calculation unit 270 provides various options to the UAV operator, and the UAV operator selects the preferred route. In this example, the calculation unit 270 determines that the distance gP for the inner orbit flight should be 56 feet 1 inch. The minimum overlap pL is 60% for an inner orbit pass (in this example using 75%). The area covered aC must be calculated based on the distance gP of 56 feet 1-inches. The Area covered is 78 feet. Next oL must be calculated based on an aC of 78 feet. The oL for each successive photograph to be taken during the inner orbit is 19 feet. 19 feet is also used as the difference in altitude for the stacked orbits.

FIG. 7B illustrates a photo taken of a building during an inner orbital pass around the building.

FIG. 8A illustrates an example of a low nadir pass 805 taken above a building 800. The low nadir pass is a boustrophedonic pass with the camera pointed directly down toward the target, without any tilt or angle. The low nadir pass 805 is flown at an altitude gP above the building 800. The altitude of the pass is calculated by adding the height of the building 800 to the calculated distance gP. An image is taken every oL feet, with a minimum overlap pL of 60%, where the oL is measured by calculating an area covered aC based on the distance gP (where gP is substituted for dF in the aC equation). In some embodiments, the vertical oL (the long portion of the boustrophedonic pass) is the same as the horizontal oL (the gap or distance between each successive long pass portion of the boustrophedonic pass). When looking from the top down in nadir passes or from the side in texture passes, the terms vertical and horizontal are relative to the picture frame, and not to absolute 3D space. In other embodiments, the oL vertical and oL horizontal are calculated as per the respective equations as listed in calculation unit 270 above.

For example, if the building has a height of 75 feet, and gP was calculated to be 75 feet, then the altitude of the low nadir pass would be 75+75=150 feet. With a picture taken every oL feet as calculated for the inner orbit pass, which in this example is 54 feet.

FIG. 8B illustrates a photo taken of a building during a low nadir pass above the building.

FIG. 9A illustrates an example of stacked outer orbital passes 910 (shown relative to inner orbit passes 710) around a building 900. In some embodiments, the distance gF of the outer orbit 910 is at a minimum 10% greater than the distance gP of the inner orbits 710. The shape of the outer orbital passes can be circumferential, circular, square, triangular, rectangular, elliptical, or have the shape of the perimeter of the target object. The passes move the camera around the building or object. In some embodiments, only one outer orbital pass is needed, and multiple stacked outer orbital passes are not needed. For example, a smaller object or building may not need more than one outer orbit pass. In some embodiments, at least two outer orbit passes which are stacked are needed to obtain the photogram metric data. The camera on the UAV is angled at a progressive downward tilt starting at 0 degrees or level with the ground, on the bottom orbital pass 905 and to a 45 degree downward tilt, at the top orbital pass 915 so that the target is always in view. The orbits all remain the same distance gF, and the same shape as the bottom outer orbit pass 905 from the building regardless of altitude. The orbits can begin with the bottom outer orbital pass 905 with each subsequent outer orbit pass conducted with an altitude increase of oL (vertical), with the orbits ending with the top outer orbital pass 915. The bottom outer orbital pass begins with the camera pointed at the base of the target centered in the frame, and each consecutive orbit is stacked with an altitude increase of oL (vertical). The top outer orbital pass 915 should be at an altitude of gF plus the height of the target. The vertical distance oL for the stacked orbits is calculated based on an area covered aC, which in turn is based on the distance gF (gF is substituted in place of dF in the aC equation), and the vertical distance iR (vertical pixel dimension). The vertical oL is calculated such that the pictures taken at each altitude in the stack have a minimum of a 60% overlap or pL with the pictures in the stacked orbits above and/or below the current picture. In some embodiments, the overlap can be in a range of less than 100% and with a minimum of 60%. For example, some embodiments have a range of a minimum of 60% overlap to a maximum of 99.99999% overlap. During a single outer orbit pass, pictures are taken every oL feet in the horizontal direction, as the camera moves around the target. During the orbit pass, oL (horizontal) feet are measured using the iR horizontal pixel dimension, while aC is measured using the gF distance as described above. The outer orbits end with the top inner orbit pass 915, such that the camera has the highest point of the target in the center of frame. The top outer orbit is the altitude of the height of the target plus gF. In some embodiments, the number of stacked orbits is calculated by dividing the height of the top outer orbit pass, by the vertical overlap. In some embodiments, the orbits may start with the top outer orbital pass 915 and decrease in an attitude of oL (vertical) and end with the bottom outer orbital pass 905.

For example to calculate the distance for the outer orbit pass, gP is used to calculate gF. In this case, the gP was 56 as in the previous example above. gF is calculated to be 72 feet 10 inches. In some embodiments, calculation unit 270 can round up. Here calculation unit 270 rounded up to 75 feet. The aC (using a gF of 75) calculated is 78 feet, and with an overlap pL of 60% for the outer orbit, the oL calculated is 31 feet. 31 feet is also used as the difference in altitude for the stacked orbits.

FIG. 9B illustrates a photo taken of a building during an outer orbital pass around the building.

FIG. 10A illustrates an example of a high nadir pass 1005 (relative to a low nadir pass 805) taken above a building 1000. The high nadir pass is a boustrophedonic pass with the camera pointed directly down toward the target, without any tilt or angle. In some embodiments, the distance gF of the high nadir pass 1005 is at a minimum 10% greater than the distance gP of the low nadir pass 805. The high nadir pass is flown at an altitude gF above the building 1000. The altitude of the pass is calculated by adding the height of the building to the calculated distance gF. An image is taken every oL feet, with a minimum overlap pL of 60%, where oL is measured by calculating an area covered aC based on the distance gF (where gF is substituted for dF in the aC equation). In some embodiments, the vertical oL (the long portion of the boustrophedonic pass) is the same as the horizontal oL (the gap or distance between each successive long pass portion of the boustrophedonic pass). When looking from the top down in nadir passes, or from the side in texture passes, the terms vertical and horizontal are relative to the picture frame, and not to absolute 3D space. In other embodiments, the oL vertical and oL horizontal are calculated as per the respective equations as listed in calculation unit 270 above.

For example, if the building has a height of 75 feet, and gP was calculated to be 56 feet (see previous examples), then gF equals 72 or rounded to 75. The altitude of the high nadir pass is 75+75=150 feet. With a picture taken every oL feet as calculated for the inner orbit pass, which in this example is 31 feet.

FIG. 10B illustrates a photo taken of a building during a high nadir pass above the building.

FIG. 11A illustrates an example of a texture pass 1105, and a texture nadir pass 1110 taken around and above a building 1100 respectively. Texture pass 1105 is a boustrophedonic pass with the camera pointed directly toward the target, without any tilt or angle. Texture pass 1105 is flown at a distance dF (where dF is calculated based on the desired picture resolution eR) from the building or target, and with a picture taken every oL feet. The oL is calculated based on a minimum overlap pL of 80% for texture passes, and the area covered is calculated based on the distance dF. In some embodiments, the overlap can be in a range of less than 100% and with a minimum of 80%. For example, some embodiments have a range of a minimum of 80% overlap to a maximum of 99.99999% overlap. In some embodiments, the vertical oL is calculated based on the camera's aspect ratio.

$$oL ( Texture or Nadir Pass ) = ( \frac{o L}{Aspect Width} ) \times Aspect Height$$

$$oL ( Texture or Nadir pass Vertical ) = aC ( Vertical ) - ( ( \frac{p L}{100} ) \times aC ( vertical ) )$$

$$oL ( Texture or Nadir pass Horizontal ) = aC ( Horizontal ) - ( ( \frac{p L}{100} ) \times aC ( Horizontal ) )$$

For example, the distance the texture pass is flown away from the building is dF. The distance dF is 21 feet and 7 inches (see previous examples). Given a desired resolution of 2.0 millimeters per pixel, and an aC calculated to be 5 feet and 5 inches, the oL is calculated to be 4 feet and 4 inches (horizontal). In some embodiments, the oL vertical and horizontal equations as shown in calculator unit 270 are used to calculate the respective oL distances. In some embodiments, the oL for the texture pass is calculated using the overall oL equation, not the horizontal and vertical oL equations.

Texture nadir pass 1110 is a boustrophedonic pass with the camera pointed directly down toward the target, without any tilt or angle. The texture nadir pass 1110 is flown at an altitude dF above the building 1100, and has a lower altitude than the low nadir pass 805. The altitude of the pass is calculated by adding the height of the building 1100 to the calculated distance dF. An image is taken every oL feet, with a minimum overlap pL of 80%, where the oL is measured by calculating an area covered aC based on the distance dF. In some embodiments, the vertical oL (the long portion of the boustrophedonic pass) is the same as the horizontal oL (the gap or distance between each successive long pass portion of the boustrophedonic pass). When looking from the top down in nadir passes, or from the side in texture passes the terms vertical and horizontal are relative to the picture frame, and not to absolute 3D space. In other embodiments the oL vertical and oL horizontal are calculated as per the respective equations as listed in calculation unit 270 above.

The oL for texture nadir pass is calculated similarly to the oL for the texture pass as described above.

FIG. 11B illustrates a picture of a building taken during a texture pass around the building.

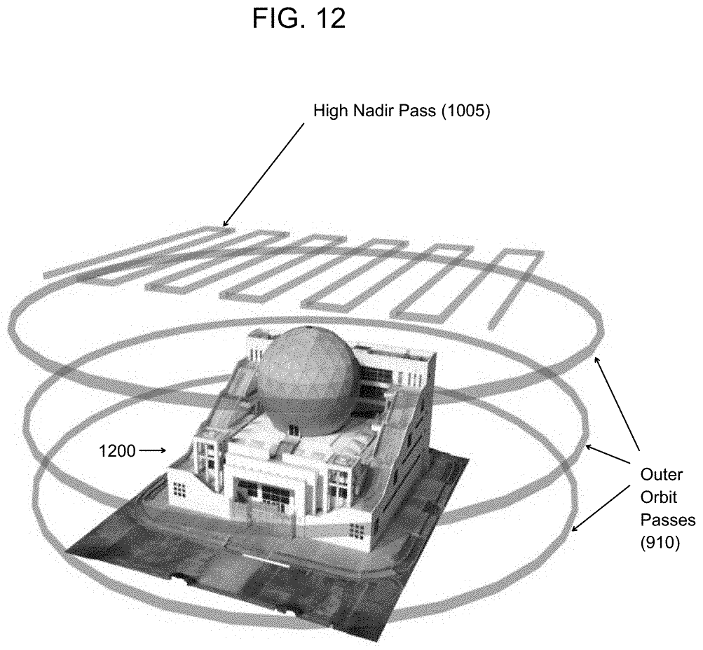

FIG. 12 illustrates another example of a high nadir pass 1005 as described in FIG. 10, and outer orbit passes 910, as described in FIG. 9 around a building 1200.

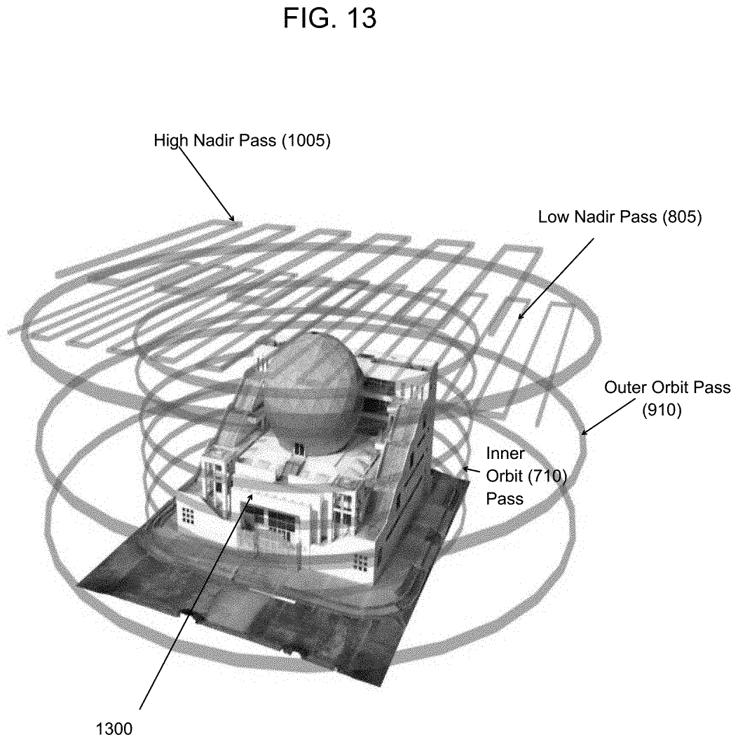

FIG. 13 illustrates another example of a high nadir pass 1005 as described in FIG. 10, a low nadir pass 805 as described in FIG. 8, outer orbital passes 910, as described in FIG. 9, and inner orbital passes 710 as described in FIG. 7, around a building 1300. The photogrammetric data captured by a camera during the high and low nadir passes, along with the inner and outer orbital passes, together produce 3D parallax data, which enables photogrammetric software to produce higher quality, 3D models with more accuracy and if desired higher polygon counts, thereby generating higher resolution 3D models.

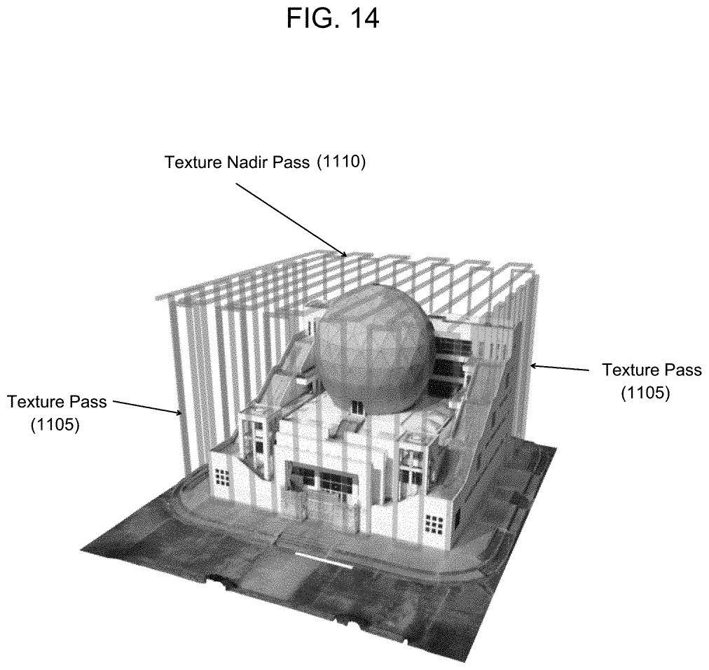

FIG. 14 illustrates another example of a texture pass 1105, and a texture nadir pass 1110 as described in FIG. 11. The photogrammetric data captured during texture pass 1105 and in some embodiments the texture nadir pass 1110 is used to generate high quality textures for use with the 3D model generated from the 3D parallax data acquired from the high and low nadir passes (1005 and 805), and inner and outer orbital passes (710 and 910) as described above.

FIG. 15 illustrates the data processing steps 1500 once the photogrammetric data is acquired during data acquisition 600.

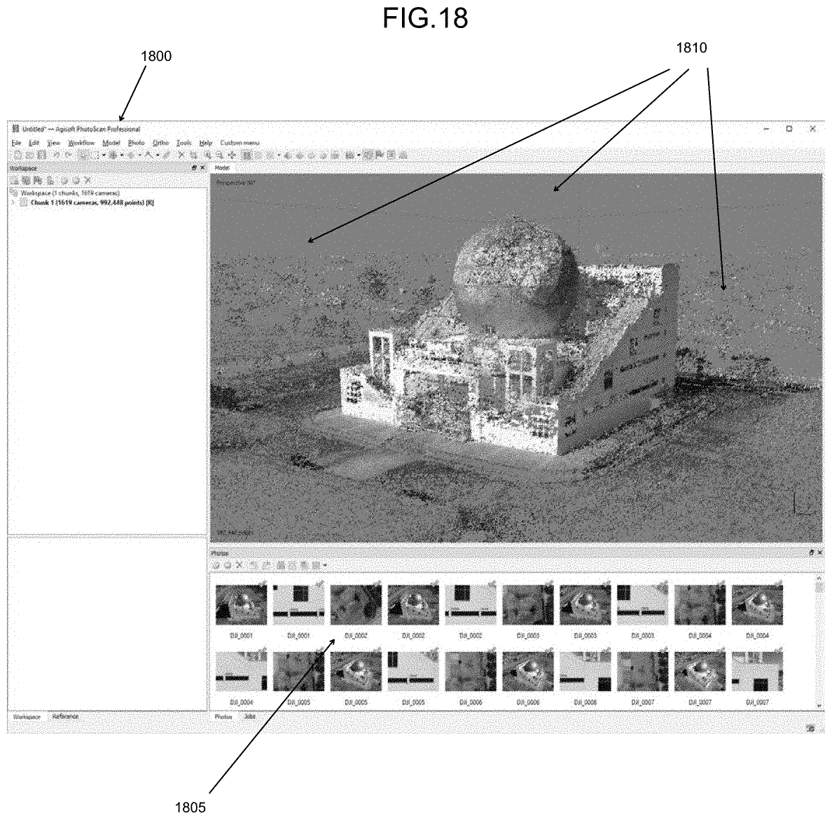

Data processing step 1510 begins with importing all of the data (including the passes which constitute the 3D parallax data, and the texture passes) acquired during data acquisition 600 into a photogrammetric software program. The photogrammetric software used as an example in FIG. 18 is Agisoft Photoscan Professional. Any photogrammetric software capable of processing the data as described hereafter can be used.

After the data is imported into the photogrammetric program, the software handles all of the data, and photographs (such as 1805, shown in FIG. 18) acquired during all of the passes together to create tie points. Tie points 1810 (as shown in FIG. 18) are common points in space shared between different photographs. The programs analyzes the photographs and data accompanied with the photographs to generate ties points between the photographs. The program aligns the photographs with respect to each other, and the generated tie points. By ensuring the photographs have sufficient tie points, the textures can be properly mapped to the 3D geometry in later steps. The images and tie points are shown as examples in FIG. 18.

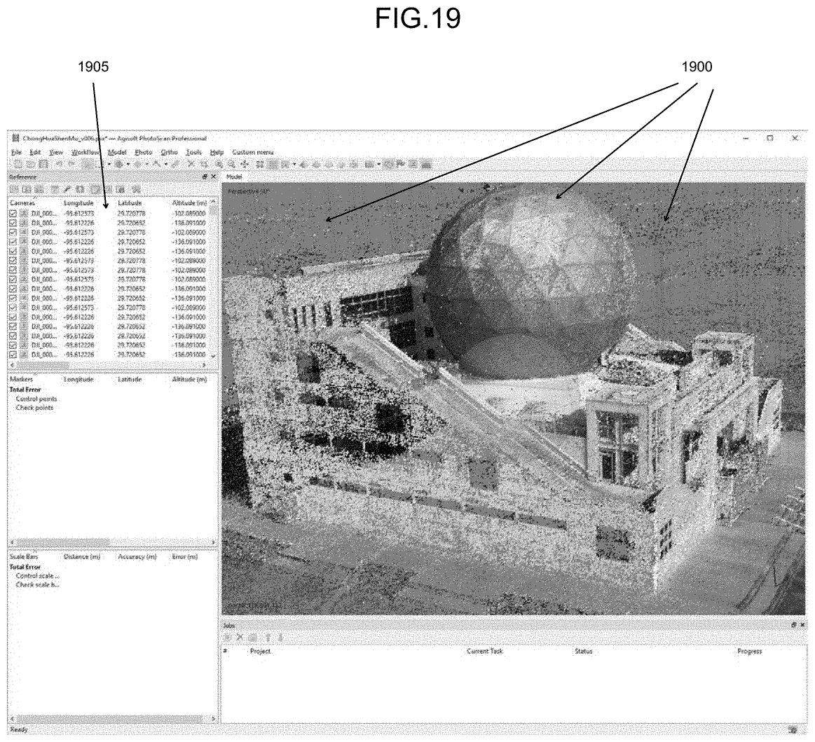

In step 1520, the original model with the generated-tie in points is duplicated. The texture pass images are then removed from the duplicated model to simplify the geometric processing and reduce the processing time. The photogrammetric software generates a dense point cloud 1900, as shown in FIG. 19. In some embodiments, the texture pass data can remain for certain portions or sub-areas of the model that require greater resolution, such as for example the two pillars at the front of the building. Depending on the memory or processing limitations of the computer used to process the data, the model can be broken up into one or more sub-models for separate processing to accelerate the processing time. There sub-models can overlap each other, and areas of the main model by 5%-10%, so that they can be recombined at a later time.

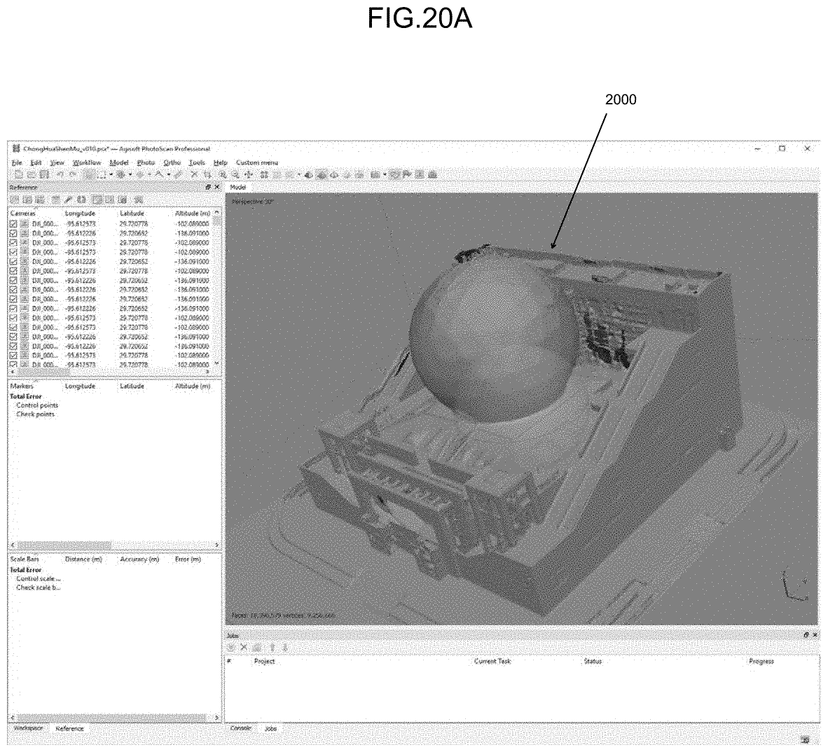

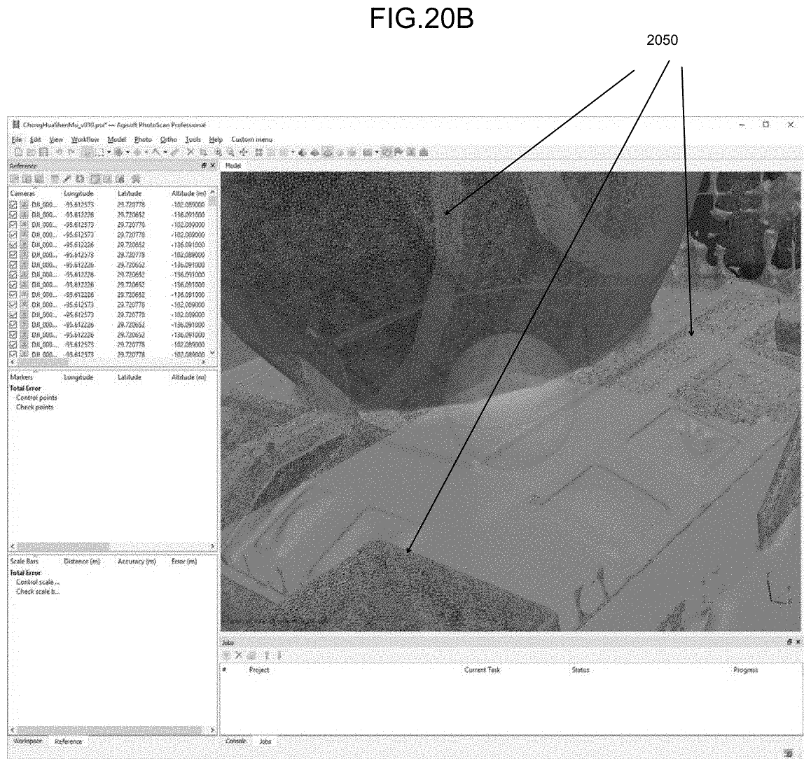

In step 1530, the dense point cloud is processed into geometry or polygons instead of points. A point cloud is a set of points in virtual space which define where polygons exist in virtual space. The same process is conducted on any sub-areas previously separated from the main model. The point cloud for the main areas and sub-areas are processed into geometry prior to any sub-areas being recombined with the main model. Once the sub-areas are recombined, a high resolution (or high polygon count) 3D is produced, without textures. An example of this 3D model 2000 and the wire frame 2050 is shown in FIGS. 20A and 20B.

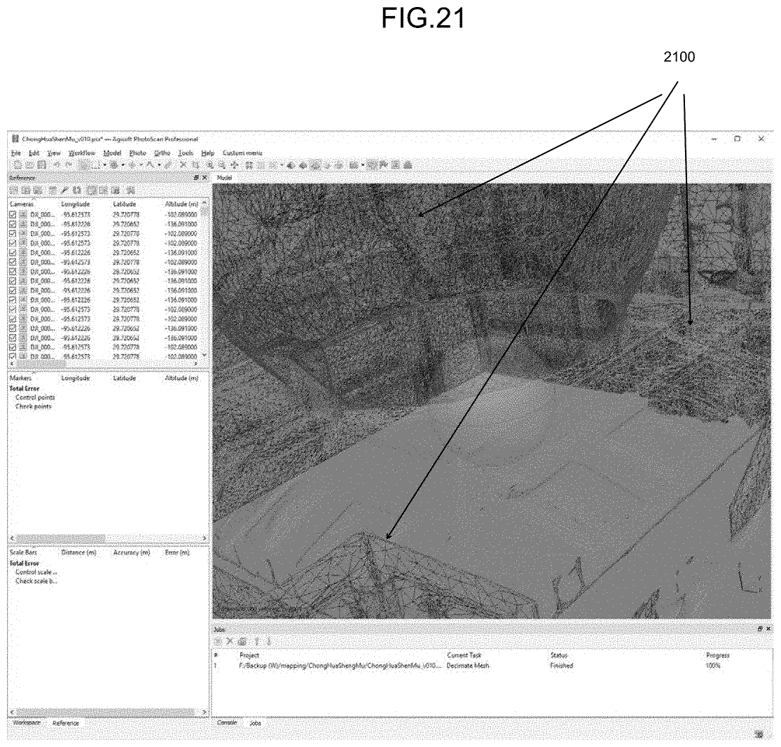

In some embodiments, where the project parameters require, the polygon count is reduced to desired levels in step 1540, for the target model, as per project parameters. For example, a 3D model for video gaming may require less polygon counts than a model for visual effects. An example of a model with reduces polygon counts, or decimated mesh 2100 is shown in FIG. 21.

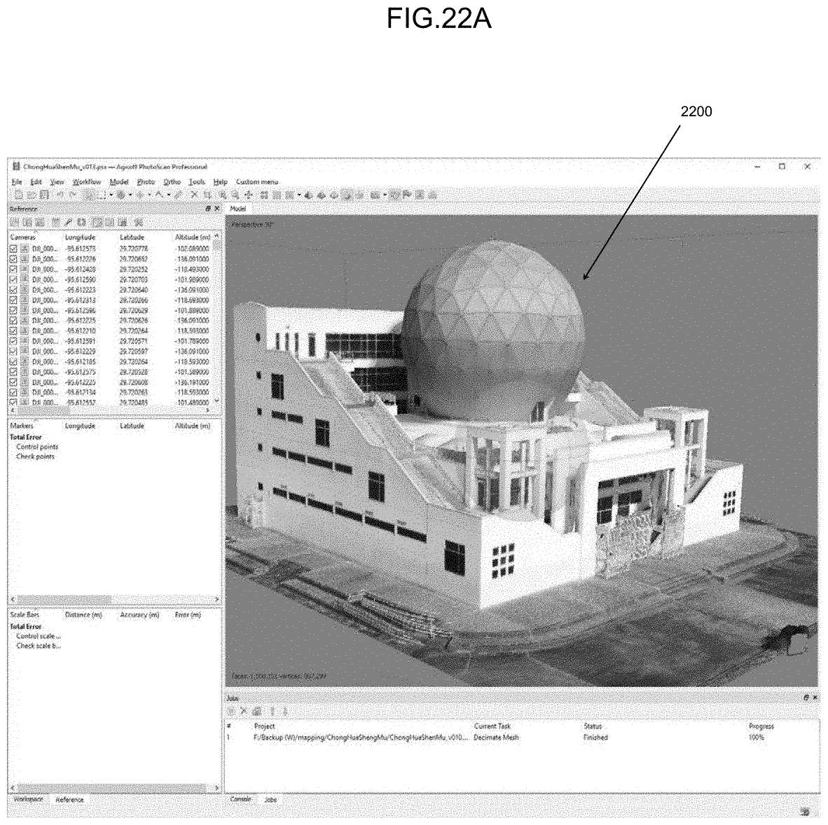

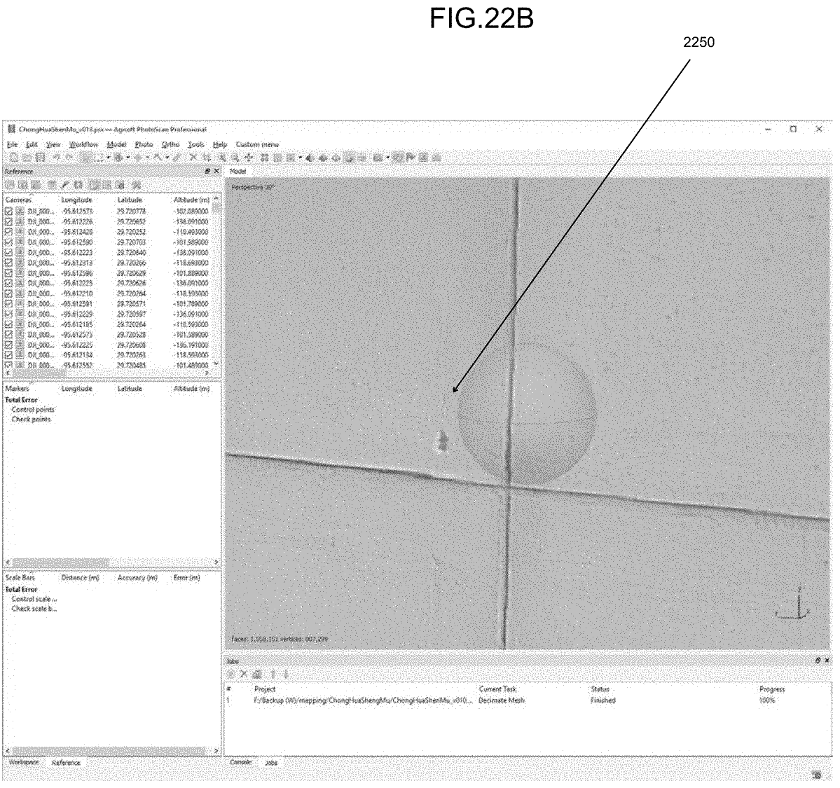

In step 1550, all images (if any present) are removed from the 3D model. The textures from the original model (pre-duplication in step 1520) are imported for use on the 3D model produced after step 1530 or 1540. The imported textures are set for high resolutions, and the textures generated can be for example images with a dimension of 8,000×8,000 pixels. The textures are then mapped to the 3D geometry. Once the high-resolution textures are integrated with the 3D model, the 3D model 2200 is created, as shown in FIG. 22A.

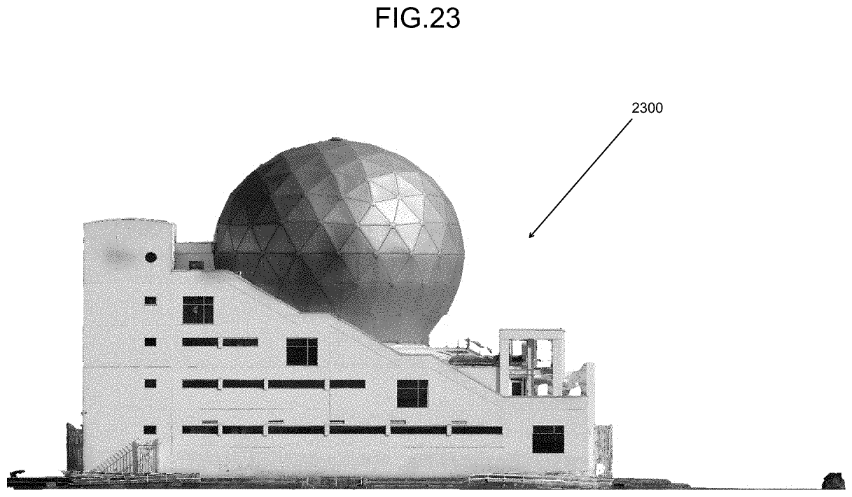

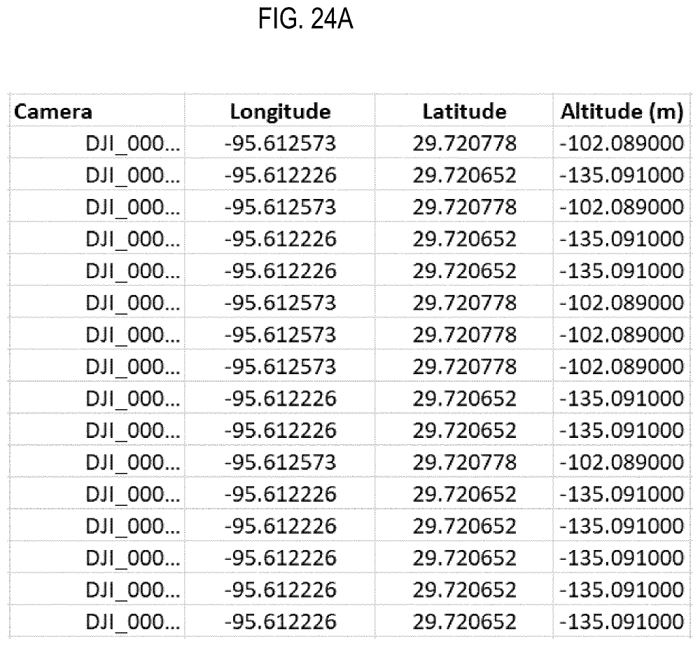

In some embodiments, side-orthogonal imagery is generated for the 3D model in step 1560. In step 1560, an orthogonal camera is placed in 3D space to render an extremely high resolution image of each side of the target or building. Depending on the capabilities of the photogrammetric software used, the 3D model may be exported for final processing in a 3D animation software for step 1560. An example of a 3D animation software used for final processing is Lightwave 3D. An example of a rendered side orthogonal image 2300 of a building is shown in FIG. 23. This process can be repeated for each side of the target or building. The final 3D model integrated with side-orthogonal imagery for the textures, is extremely high resolution.

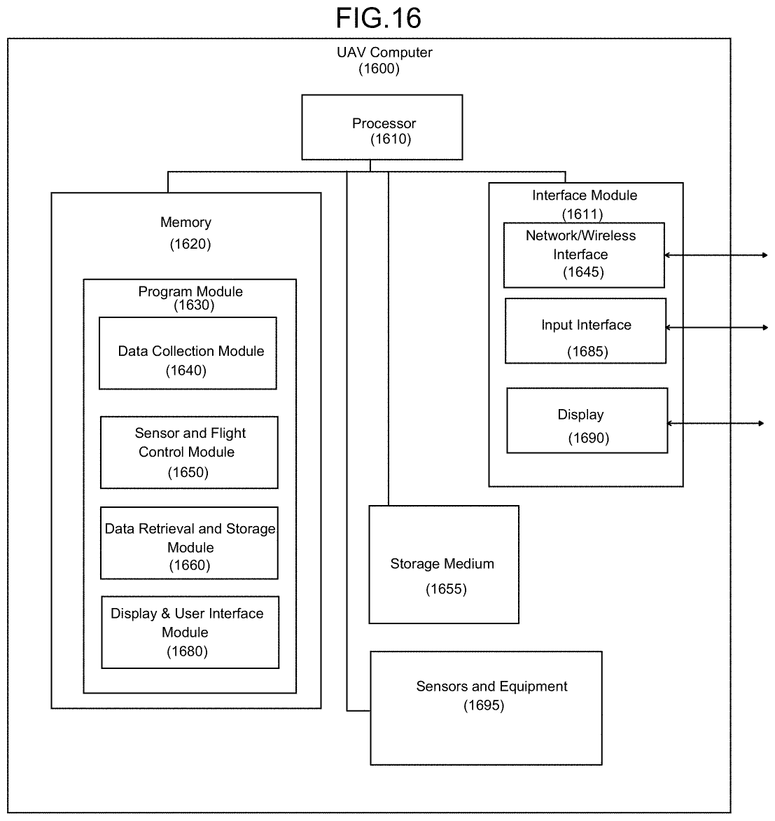

FIG. 16 is a block diagram of a Method computer system used to implement the method and system disclosed herein. In some embodiments, method computer 1600 can be located on a UAV. Method computer 1600 includes a processor 1610 connected or coupled to a memory 1620. Method computer 1600 is not limited to a stand-alone device but can be coupled to other devices (not shown) in a distributed computer network or processing system.

Processor 1610 is configured logic circuitry that responds to and executes instructions.

Memory 1620 is a tangible storage medium that is readable by processor 1610. Memory 1620 stores data and instructions for controlling the operation of processor 1610. Memory 1620 can comprise random access memory (RAM), a hard drive, a read only memory (ROM), or any combination thereof. Memory 1620 can be a non-transitory computer-readable medium.

Memory 1620 contains a program module 1630. Program module 1630 includes instructions for controlling processor 1610 to perform the operations of the data collection module 1640, sensor and flight control module 1650, data retrieval and storage module 1660, and display and user interface module 1680.

In some embodiments, data collection module 1640 can perform all processes as described in data collection unit 240 above. Data collection module 1640 communicates with the Sensors and Equipment, to collect data from sensors such as the camera. The sensors and Equipment 1695 can include, but is not limited to, cameras, accelerometers, gyroscopes, motors, propellers, radar, lidar, sonar, optical, a device for measuring altitude, and infrared sensors, that can be located on a UAV. Sensor and flight control module 1650 can control a UAV, such that the UAV is able to autonomously fly a set flight path (programmed route), or enables a UAV operator to control the UAV through a remote control device. Data retrieval and storage module 1660 can perform all processes as described in data storage unit 250 and data retrieval unit 260 above. Data retrieval storage module 1660 stores data collected from data collection module 1640. In some embodiments, memory 1620 includes instructions for controlling processor 1610 to perform operations of a calculation module (not shown). The calculation module can perform all processes as described in calculation unit 270 above. The calculation module is able to provide optimal flight paths based on collected data from input data collection 200. In some embodiments, display and user interface module 1680 can perform processes to enable a user to use an interface display to make adjustments to the flight path of the UAV, or enter various types of data into the UAV system.

The program module 1630 can be implemented as a single module or as a plurality of modules that operate in cooperation with one another. In some embodiments, program module 1630 is installed in memory 1620. Program module 1630 can be implemented in software, hardware, such as electronic circuitry, firmware, or any combination thereof.

In some embodiments, program module 1630 is pre-loaded into memory 1620. In other embodiments, program module 1630 is configured to be loaded from a storage medium, such as storage medium 1655.

Storage medium 1655 can include any tangible storage medium that stores program module 1630, or any data stored by data storage module 1650. Storage medium 1655 can include a floppy disk, a compact disk, a magnetic tape, memory sticks, a read only memory, an optical storage media, universal serial bus (USB) flash drive, zip drive, or other type of electronic storage. Storage media 1655 can be located on a remote storage system or coupled to Method computer 1600 via communication network (such as a local or wide area network).

In some embodiments, interface module 1611 comprises a network and wireless interface 1645, an input interface 1685, and a display 1690.

A communication network can be connected to Method computer 1600 through network and wireless interface 1645. Network and wireless interface 1645 also enables control of a UAV through a remote-control system, that can be operated by a UAV technician or operator (not shown).

Data collection module 1640 can receive data from interface module 1611 and/or from storage medium 1655, and/or through network interface 1645.

Data retrieval and storage module 1660 can then store the data in memory 1620, or storage medium 1655, or send the data to a server or data processing computer through network interface 1645, or any combination thereof.

Through instructions provided by memory 1620, and in particular, each module, 1640, 1650, 1660, 1680, and in some embodiments a calculation unit, processor 1610 reads and writes data onto a data storage medium such as 1655. The storage of calculated data, and such as optimal flight paths, and flight paths avoiding obstructions from a calculation unit on the method computer or a UAV computer and/or server or data processing computer onto a storage medium such as 1655, enables these stored calculations to be used in future calculations based on updated data, inputs or instructions received at a future time. In this way, the UAV and/or server or data processing computer is modified to perform operations and tasks that the UAV and/or server or data processing computer was previously incapable of performing or completing. Also, in this way, the performance and functions of a UAV and/or server computer is improved.

Data retrieval and storage module 1660 retrieves data stored in data storage 1655 and can retrieve data from memory 1620, or any other storage medium accessible through network interface 1645.

In some embodiments, data retrieval and storage module 1660 can supply data to a calculator module stored on memory 1620.

Display and user interface module 1680 receives data from a calculator module stored in the memory of a server computer. In this embodiment, module 1680 receives the data through network interface 1645. Interface module 1680, in some embodiments, receives data from a calculator module stored on memory 1620 of the Method computer 1600.

Display and user interface module 1680 configures the data from the calculator module for display on display 1690. Module 1680 displays a user interface on display 1690. Display 1690 on the UAV can display possible and optimal flight paths, and display obstructions.

A user can input data into a user interface shown on display 1690 on the UAV, through input interface 1685. Input interface 1685 can include, but is not limited to, a mouse and keyboard, touch screen, USB, scanner or other input device.

In some embodiments, display and interface module 1680 receives the data from input interface 1685, and provides the data to data retrieval and storage module 1660, and/or a calculator module stored on the memory of either Method computer 1600 or a server or data processing computer through network interface 1645.

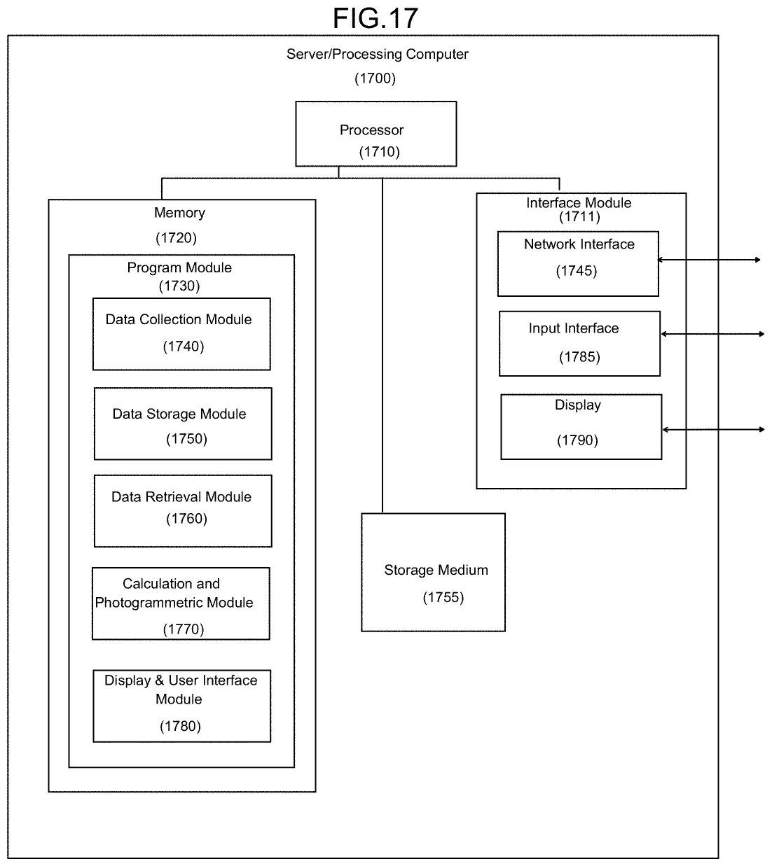

Referring to FIG. 17, Server computer 1700 includes a processor 1710 coupled to a memory 1720. Server computer 1700 is not limited to a stand-alone device, but can be coupled to other devices (not shown) in a distributed computer network or processing system.

Processor 1710 is configured with logic circuitry. The logic circuitry responds to and executes instructions.

Memory 1720 is a tangible storage medium that is readable by processor 1710. Memory 1720 stores data and instructions for controlling the operation of processor 1710. Memory 1720 can comprise random access memory (RAM), a hard drive, a read only memory (ROM), or any combination thereof. Memory 1720 can be a non-transitory computer-readable medium.

Memory 1720 has a program module 1730. Program module 1730 includes instructions for controlling processor 1710 to perform the operations of the data collection module 1740, data storage module 1750, data retrieval module 1760, calculation and photogrammetric module 1770, and display and user interface module 1780.

Data collection module 1740 can perform all processes as described in data collection unit 240 above. Data storage module 1750 is capable of performing all processes as described in data storage unit 250 above. Data retrieval module 1760 can perform all processes as described in data retrieval unit 260 above. The calculation and photogrammetric module 1770 can perform all processes as described in calculation unit 270, and data processing unit 1500 above. Display and user interface module 1780 can perform all processes as described in display and user interface module 1680 above.

The program module 1730 can be implemented as a single module or as a plurality of modules that operate in cooperation with one another. In some embodiments, program module 1730 is installed in memory 1720, and can be implemented in software, hardware, such as electronic circuitry, firmware, or any combination thereof.

In some embodiments, program module 1730 is pre-loaded into memory 1720. In other embodiments, program module 1730 can be configured to be loaded from a storage medium such as storage medium 1755.

Storage medium 1755 can include any tangible storage medium that stores program module 1730, or any data stored by data storage module 1750. Storage medium 1755 can include a floppy disk, a compact disk, a magnetic tape, memory sticks, a read only memory, an optical storage media, universal serial bus (USB) flash drive, zip drive, or other type of electronic storage. Storage media 1755 can be located on a remote storage system, or coupled to Server computer 1700 via communication network (such as a local or wide area network).

Interface module 1711 comprises a network interface 1745, an input interface 1785, and a display 1790. A communication network can be connected to server computer 1700 through network interface 1745.

Data collection module 1740 can receive data from interface module 1711 and/or from storage medium 1755, and/or through network interface 1745.

Data storage module 1750 can then store the data in Memory 1720, or storage medium 1755, or sends the data to a client computer through network interface 1745, or any combination thereof.

Through instructions provided by memory 1720, and in particular, each module, 1740, 1750, 1760, 1770, and 1780, processor 1710 reads and writes data onto a data storage medium such as 1755. The storage of calculated data, and such as optimal flight paths, and flight paths avoiding obstructions from a calculation unit on a UAV computer and/or server computer onto a storage medium such as 1755, enables these stored calculations to be used in future calculations based on updated data, inputs or instructions received at a future time. Calculation unit 1770 further uses the data acquired in data acquisition 600, to produce a 3D by processing the data as described in data processing unit 1500. The final 3D model generated by calculation module 1770 is new and useful data, which did not exist prior to the execution of the instructions in calculation module 1770. In this way, the UAV and/or server or computer is modified to perform operations and tasks that the UAV and/or server or computer was previously incapable of performing or completing. Also, in this way, the performance and functions of a UAV and/or server computer is improved.

Data retrieval module 1760 retrieves data stored by data storage module 1750. Data retrieval module 1760 can retrieve data from memory 1720, storage medium 1755, or any other storage medium accessible through network interface 1745.

In some embodiments, data retrieval module 1760 can supply data to calculator module 1770 stored on memory 1720. In some embodiments, calculator module 1770 can send optimal flight path calculations, and distances, or various flight path options to avoid obstructions (or any other data capable of being provided by calculation unit 270) to a storage medium such as 1755, or the display and user interface module 1780 or interface module 1711 of a Method computer 1600.

Interface module 1780, in some embodiments, receives data from a calculator module stored on memory 1720 of the server computer 1700.

Display and user interface module 1780 configures the data such as a 3D model, from the calculator module 1770 for display on display 1790. Module 1780 displays a user interface on display 1790.

A user can input data into a user interface shown on display 1790, through input interface 1785. Input interface 1785 can include, but is not limited to, a mouse and keyboard, touch screen, USB, scanner or other input device.

In some embodiments, display and interface module 1780 receives the data from input interface 1785, and provides the data to data storage module 1750, and/or a calculator module, or display or interface module 1780, or interface module 1611 of a Method computer 1600 through network interface 1745.

In some embodiments, Method computer 1600 is the computer or network of computers on which data is collected, and stored, and/or concurrently provided to server computer 1700, through use of a local area network and/or wide area network

The data is transmitted over a local area network and/or a wide area network. The local area network may be a wireless or wired network. In some embodiments, the wide area network is the internet. Method computer 1600 can be directly connected to a wide area network, or can be connected to a local area network. Data can also be collected from various sources, and third parties over the wide area network.

FIG. 18 illustrates tie in points generated from processing of the photogram metric data as described above in step 1510. 1800 is an example of the photogrammetric software used (Agisoft Photoscan Professional). 1810 illustrates the tie in points as described in step 1510 above. 1805 provides examples of the images used to generate the tie in points as described in step 1510.

FIG. 19 illustrates dense cloud points generated from processing of the photogrammetric data as described above in step 1520. 1900 illustrates the point clouds generated as described above in step 1520. 1905 illustrates data known as the geotag that may accompany each image acquired in data acquisition 600, such as longitude, latitude, and altitude. The geotag data may enable more accuracy when generating tie in points or point clouds.

FIG. 20A illustrates the solid geometric 3D model 2000 generated from the point clouds as described in step 1530 above.

FIG. 20B illustrates the wireframe 2050 of the solid geometric 3D generated from the point clouds as described in step 1530 above.

FIG. 21 illustrates the decimated mesh 2100 of the 3D model as described in step 1540.

FIG. 22A illustrates the 3D model 2200 after integration with high resolution textures as described in step 1550 above.

FIG. 22B illustrates a close up 2050 of the side of the 3D model 2200 after integration with high resolution textures as described in step 1550 above. A bullet hole from a .22 caliber firearm is visible on the image of the closeup 2050.

FIG. 23 illustrates a very high-resolution side orthogonal image 2300 of the 3D model as described in step 1560. In some embodiments, image 2300 is an image having pixel dimensions of 43,922×20,983. The high pixel density provides an inspector the resolution required to adequately inspect the structure or target, while also have the overall target or structure in context.

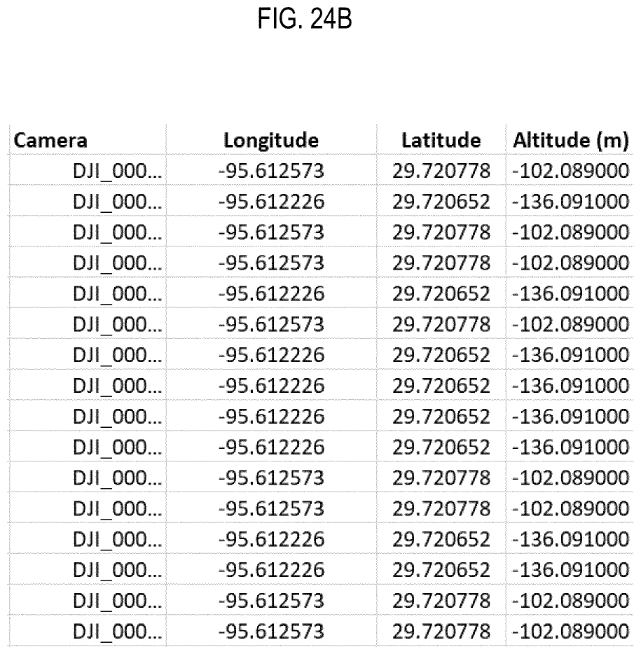

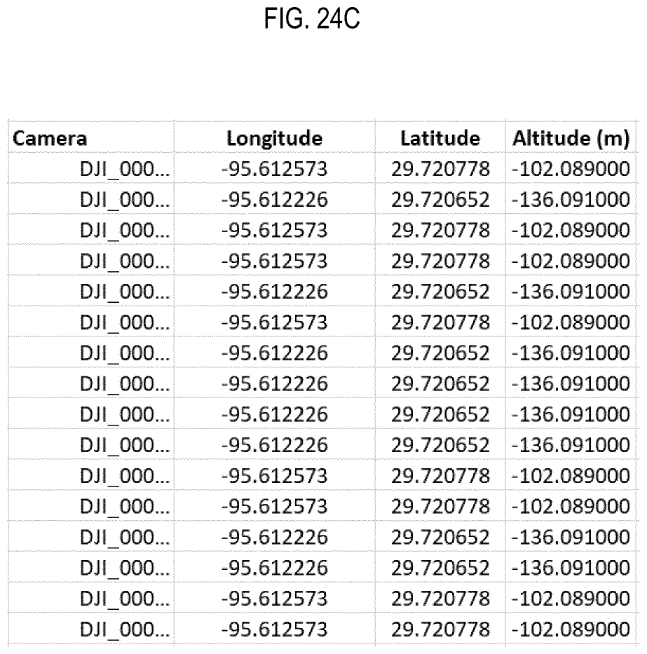

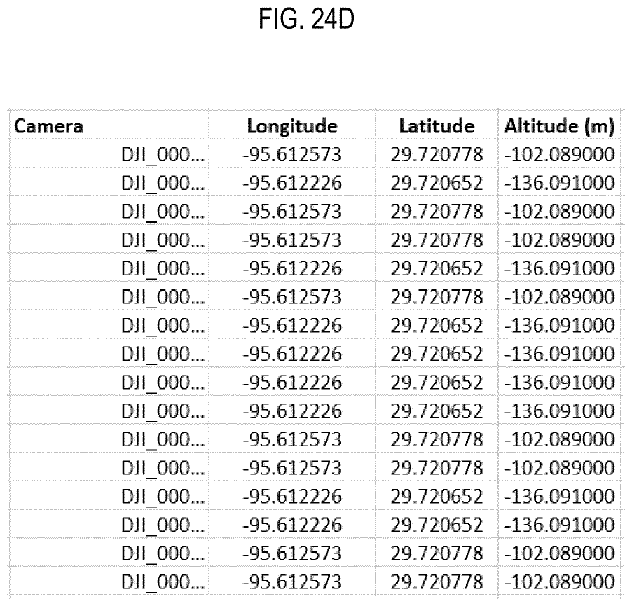

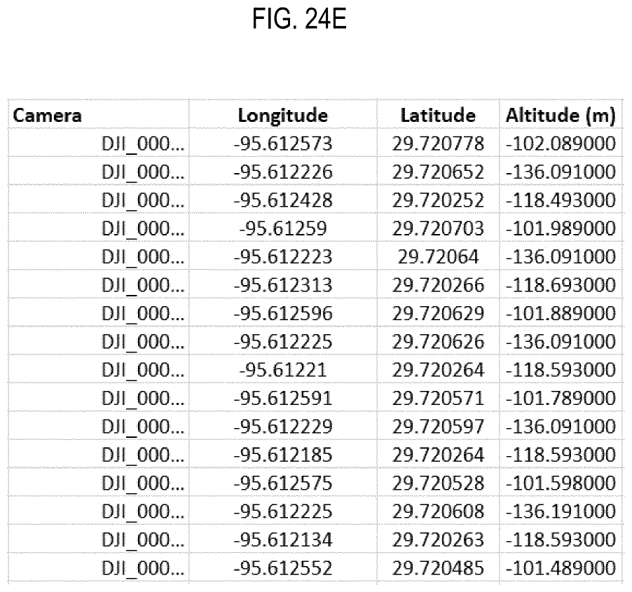

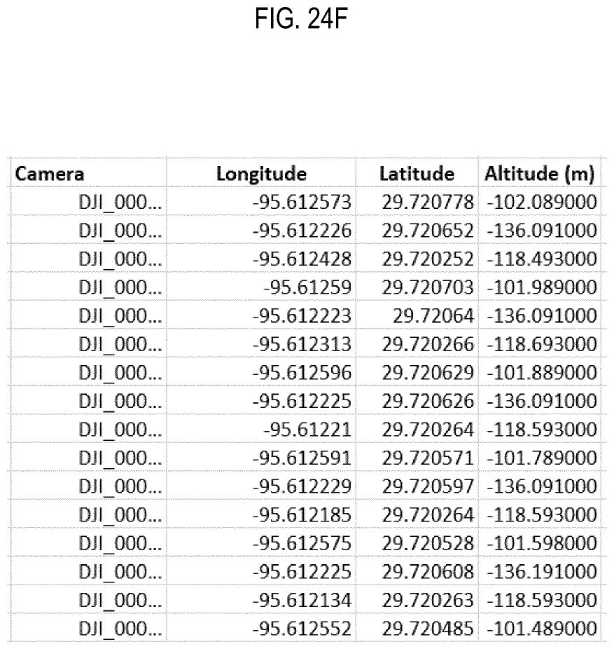

FIGS. 24A-24F show positional data from FIGS. 19, 20A, 20B, 21, 22A and 22B respectively, specifically longitude, latitude and altitude data obtained from images taken by the drone.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure not be limited to the particular embodiment(s) disclosed as the best mode contemplated.

It will be understood that each block of the flowchart illustrations described herein, and combinations of blocks in the flowchart illustrations, can be implemented by computer program instructions. These program instructions can be provided to a processor to produce a machine, such that the instructions, which execute on the processor, create means for implementing the actions specified in the flowchart block or blocks. The computer program instructions can be executed by a processor to cause a series of operational steps to be performed by the processor to produce a computer-implemented process such that the instructions, which execute on the processor to provide steps for implementing the actions specified in the flowchart block or blocks. The computer program instructions can also cause at least some of the operational steps shown in the blocks of the flowchart to be performed in parallel. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the present disclosure.

Accordingly, blocks of the flowchart illustrations support combinations for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions. The foregoing examples should not be construed as limiting and/or exhaustive, but rather, as illustrative use cases to show an implementation of at least one of the various embodiments of the present disclosure.

What is claimed is:

1. A method of acquiring photogrammetric data comprising:
using a camera to capture consecutive images of a target object by moving the camera along at least five paths with a predetermined distance between each consecutive image;
capturing each consecutive image along each of the at least five paths, wherein the at least five paths comprise an inner orbital pass, an outer orbital pass, a high bustrophedonic nadir pass, a bustrophedonic texture pass, and a bustrophedonic texture nadir pass;
retaining the target object within a field of view of the camera when capturing each consecutive image; and
generating photogrammetric data of the target object.

2. The method of claim 1, wherein the predetermined distance is a percentage overlap between each consecutive image.

3. The method of claim 2, wherein the percentage overlap between each consecutive image is at least sixty percent.

4. The method of claim 1, wherein the bustrophedonic texture pass and the bustrophedonic texture nadir pass have a percentage overlap between each consecutive image of at least eighty percent.

5. The method of claim 1, wherein the inner orbital pass and the outer orbital pass each have a predetermined number of corresponding vertically stacked orbits, and wherein each one of the corresponding vertically stacked orbits are separated by a vertical overlap.

6. The method of claim 5, wherein each one of the corresponding vertically stacked orbits has a topmost vertically stacked orbit, and
wherein the camera has a camera angle of forty five degrees tilted down toward the target object so that the target object is at the center of the field of view when the camera is on the topmost vertically stacked orbit.

7. The method of claim 5, wherein the inner orbital pass and the outer orbital pass each have an orbital pass shape, and wherein the orbital pass shape is selected from the group consisting of a circular shape, a rectangular shape, a square shape, a triangular shape, an elliptical shape, and a shape corresponding to a perimeter of the target object.

8. The method of claim 7, wherein each one of the corresponding vertically stacked orbits have the same orbital shape as the inner orbital pass and the outer orbital pass.

9. The method of claim 1, further comprising the steps of utilizing an unmanned aerial vehicle to move the camera between each of the consecutive images.

10. The method of claim 1, further comprising the step of utilizing a movement mechanism selected from the group consisting of a robotic arm, a guided rail, and a guided track to move the camera between each of the consecutive images.

11. The method of claim 1, further comprising the step of: reaching a target resolution for each consecutive image by adjusting a capture distance the camera is from the target object during each one of the at least five paths including the inner orbital pass, the outer orbital pass, the high bustrophedonic nadir pass, the bustrophedonic texture pass, and the bustrophedonic texture nadir pass, based on physical dimensions of the target object.

12. The method of claim 11, wherein the physical dimensions are selected from the group consisting of height, width, length, circumference, and perimeter.

13. The method of claim 11, further comprising the step of adjusting the capture distance based on a combination of the physical dimensions of the target object and obstructions.

14. The method of claim 1, wherein the at least five paths further comprise a sixth pass.

15. The method of claim 14, wherein the sixth pass is a low bustrophedonic nadir pass.

16. A method of acquiring photogrammetric data comprising:
using a camera to capture consecutive images of a target object by moving the camera along six paths with a predetermined distance between each consecutive image;
capturing each consecutive image along each of the six paths, wherein the six paths comprise an inner orbital pass, an outer orbital pass, a low bustrophedonic nadir pass, a high bustrophedonic nadir pass, a bustrophedonic texture pass, and a bustrophedonic texture nadir pass; and
retaining the target object within a field of view of the camera when capturing each consecutive image; and
generating photogrammetric data of the target object.

17. The method of claim 16, wherein the predetermined distance is a percentage overlap between each consecutive image, and wherein the percentage overlap between each consecutive image is at least sixty percent.

18. The method of claim 17, wherein the photogram metric data includes texture imagery and geometry imagery.

19. A computer implemented method of generating a three-dimensional model comprising the steps of:
acquiring photogrammetric data of a target object including geometry imagery and texture imagery;
creating tie points from geometry imagery and texture imagery;
excluding the texture imagery from the geometry imagery;
generating a dense point cloud from the geometry imagery;
processing the dense point cloud into three-dimensional geometry;
reducing a polygon count of the three-dimensional geometry;
reintroducing texture imagery to the three-dimensional geometry and removing geometry imagery;
creating textures by projecting texture imagery onto the three-dimensional geometry.

20. A method of acquiring photogrammetric data and generating a three-dimensional model comprising the steps of:
using a camera to capture consecutive images of a target object by moving the camera along six paths with a predetermined distance between each consecutive image;
capturing each consecutive image along each of the six paths, wherein the six paths comprise an inner orbital pass, an outer orbital pass, a low bustrophedonic nadir pass, a high bustrophedonic nadir pass, a bustrophedonic texture pass, and a bustrophedonic texture nadir pass;
retaining the target object within a field of view of the camera when capturing each consecutive image;
generating photogrammetric data of the target object including geometry imagery and texture imagery;
creating tie points from geometry imagery and texture imagery;
excluding the texture imagery from the geometry imagery;
generating a dense point cloud from the geometry imagery;
processing the dense point cloud into three-dimensional geometry;
reducing a polygon count of the three-dimensional geometry;
reintroducing texture imagery to the three-dimensional geometry; removing geometry imagery; and
creating textures by projecting texture imagery onto the three-dimensional geometry.
